(19) United States
(12) Patent Application Publication
(10) Pub. No.: US 2016/0005156 A1
(43) Pub. Date: Jan. 7, 2016

(54) INFRARED SELECTING DEVICE AND METHOD

(71) Applicant: Hao WANG, Zhejiang (CN)

(72) Inventor: Hao Wang, Hangzhou (CN)

(21) Appl. No.: 14/758,248

(22) PCT Filed: Dec. 26, 2013
(86) PCT No.: PCT/CN2013/090609

§ 371 Date: Jun. 29, 2015

(30) Foreign Application Priority Data
Dec. 27, 2012 (CN) 201210584184.1

(51) Int. Cl. G06T 7/00; H04N 5/33; H04N 5/232; G06K 9/62

(52) U.S. Cl. CPC G06T 7/001; G06K 9/6201; H04N 5/33; H04N 5/23293; G06T 7/0044; G06K 9/6267

(57) ABSTRACT

This invention provides an infrared selecting device and method, which relates to a thermal imaging device, a thermal image processing device, and infrared thermal imaging detection. The conventional thermal imaging device is excessively dependent on subjective experience of users to photograph a thermal image of a body, causing great workload and failing to ensure the quality of the thermal image. In the invention, a reference image is displayed, specified information of a specified body thermal image can be automatically detected from the acquired thermal imaging data frame, or auxiliary information is considered. Thus, the thermal imaging data frame satisfying a specified condition can be automatically selected from the continuously acquired thermal imaging data frames, thereby facilitating subsequent processing or operation, such as inform, analysis, or storage, simplifying photographing operation, and improving the photographing speed and the quality of the thermal image.

### BACKGROUND OF THE INVENTION

1. Field of the Invention

The invention relates to infrared detection filed and, more particularly, to an infrared selecting device and method.

2. Description of the Related Art

Since thermal imaging detection is applied, users are always confused of recognition of a body imaging shape and the control of a photographing distance when correctly photographing a photographing part at a photographing angle, which is dependent on subjective ideas and experience of the users. Thus, at present, the users need to think at the same time of photographing to ensure the detecting quality, thereby slowing a photographing speed. If the speed is accelerated, a key photographing part or defects of the body may be missed, affecting a state assessment effect. Usually the users cannot achieve the better detection level until increasing practice accumulation for several years.

The technical persons in the field always try to solve this problem. In the prior art, a reference image reflecting morphological characters of a photographed body and an infrared thermal image are continuously overlapped and displayed. The users may photograph specified bodies with the visual reference of the reference image, to ensure a position and a dimension of the specified body thermal image in the infrared thermal image and the correction of the morphological character of the specified body thermal image, thereby ensuring the photographing quality. For example, a patent with a publication number of CN201210008404.6 discloses the above device for photographing thermal images.

However, in the above method, the users may manually judge the matching extent between the reference image and the specified body thermal image by eyes, thereby easily causing visual fatigue. As a handheld thermal imaging device is used, the aiming photographing operation easily causes fatigue, and the repeated aiming prolongs the photographing time and affects the quality of the photographed thermal image. Further, the above operation is inflexible, and the aiming requirement is high.

Therefore, an infrared selecting device, without excessively depending on subjective ideas of the users and capable of selecting special information related to the thermal imaging data frame satisfying a specified condition from the acquired thermal imaging data frame, is needed, thereby facilitating the processing or operation such as analyzing, informing, or storing, further to simplify the operation and acquire the thermal imaging data frame with the better quality.

### BRIEF SUMMARY OF THE INVENTION

The invention provides an infrared selecting device and method. A reference image may be displayed in an infrared thermal image, specified information, such as a position, a dimension, an inclined angle, and a correlation degree value of a specified body thermal image in the acquired thermal imaging data frame, may be automatically detected, or auxiliary information may be considered. Thus, special information related to the thermal imaging data frame satisfying a specified condition may be automatically selected, thereby simplifying the photographing operation, accelerating the photographing speed, and improving the quality of the thermal image. Thereby, the invention provides the following device and method.

An infrared selecting device may include a photographing part for continuously photographing to acquire the thermal imaging data frame, a display controlling part for controlling to display a reference image and a dynamic infrared thermal image acquired according to the acquired thermal imaging data frame, a detecting part for detecting specified information related to a specified body thermal image based on the acquired thermal imaging data frame, a comparing part for comparing the specified information acquired by the detecting part and/or an evaluating value acquired according to the acquired specified information with a specified comparing value, and a selecting part for selecting special information related to the specified thermal imaging data frame based on a comparing result of the comparing part.

An infrared selecting device may include an acquiring part for continuously acquiring the thermal imaging data frame, a display controlling part for controlling to display a reference image and a dynamic infrared thermal image acquired according to the acquired thermal imaging data frame, a detecting part for detecting specified information related to a specified body thermal image based on the acquired thermal imaging data frame, a comparing part for comparing the specified information acquired by the detecting part and/or an evaluating value acquired according to the acquired specified information with a specified comparing value, and a selecting part for selecting special information related to the specified thermal imaging data frame based on a comparing result of the comparing part.

An infrared selecting method in the invention may include a photographing step for continuously photographing to acquire the thermal imaging data frame, a display controlling step for controlling to display a reference image and a dynamic infrared thermal image acquired according to the acquired thermal imaging data frame, a detecting step for detecting specified information related to a specified body thermal image based on the acquired thermal imaging data frame, a comparing step for comparing the specified information acquired in the detecting step and/or an evaluating value acquired according to the acquired specified information with a specified comparing value, and a selecting step for selecting special information related to the specified thermal imaging data frame based on a comparing result of the comparing step.

An infrared selecting method in the invention may include an acquiring step for continuously acquiring the thermal imaging data frame, a display controlling step for controlling to display a reference image and a dynamic infrared thermal image acquired according to the acquired thermal imaging data frame, a detecting step for detecting specified information related to the specified body thermal image based on the acquired thermal imaging data frame, a comparing step for comparing the specified information acquired in the detecting step and/or an evaluating value acquired according to the acquired specified information with a specified comparing value, and a selecting step for selecting special information related to the specified thermal imaging data frame based on a comparing result of the comparing step.

These and other aspects and advantages of the present invention will be described with regard to the following description.

### BRIEF DESCRIPTION OF THE DRAWINGS

FIG. 1 is a block diagram showing a thermal imaging device 100 in a first embodiment of the invention;

FIG. 2 is an outline diagram showing the thermal imaging device 100 in the first embodiment;

FIG. 3 is a schematic diagram showing body information, constituted data of reference images, and body identifying information stored in a storage medium in the first embodiment;

FIG. 4 is a schematic diagram showing detecting windows with different parameters;

FIG. 5 is a schematic diagram showing the detecting window set in a detecting area for detection;

FIG. 6 is a schematic diagram showing display interfaces in the first embodiment;

FIG. 7 is a flow chart of the first embodiment;

FIG. 8 is a flow chart of a second embodiment;

FIG. 9 is a schematic diagram showing display interfaces in the second embodiment;

FIG. 10 is a flow chart of a third embodiment;

FIG. 11 is a flow chart of a fourth embodiment.

### DETAILED DESCRIPTION OF THE INVENTION

This invention may be further described according to the drawings. For better understanding, the following described embodiments do not limit the scope of the invention and can be changed to different forms in the scope of the invention. Further, although a portable thermal image photographing device is taken for example, the photographing function in the invention is not necessary, and any thermal imaging data source may be used for performing detection of specified bodies. Therefore, the invention is widely applied to thermal image processing devices for receiving and processing the thermal images from outside. The thermal image processing device may be different devices such as a personal computer, a personal digital assistant.

### Embodiment One

In the first embodiment, based on thermal imaging data frames continuously photographed by a photographing part 1, a thermal imaging device 100 (an infrared selecting device) detects a correlation degree between the acquired thermal imaging data frame and body identifying information, and selects special information related to the thermal imaging data frame based on a comparing result.

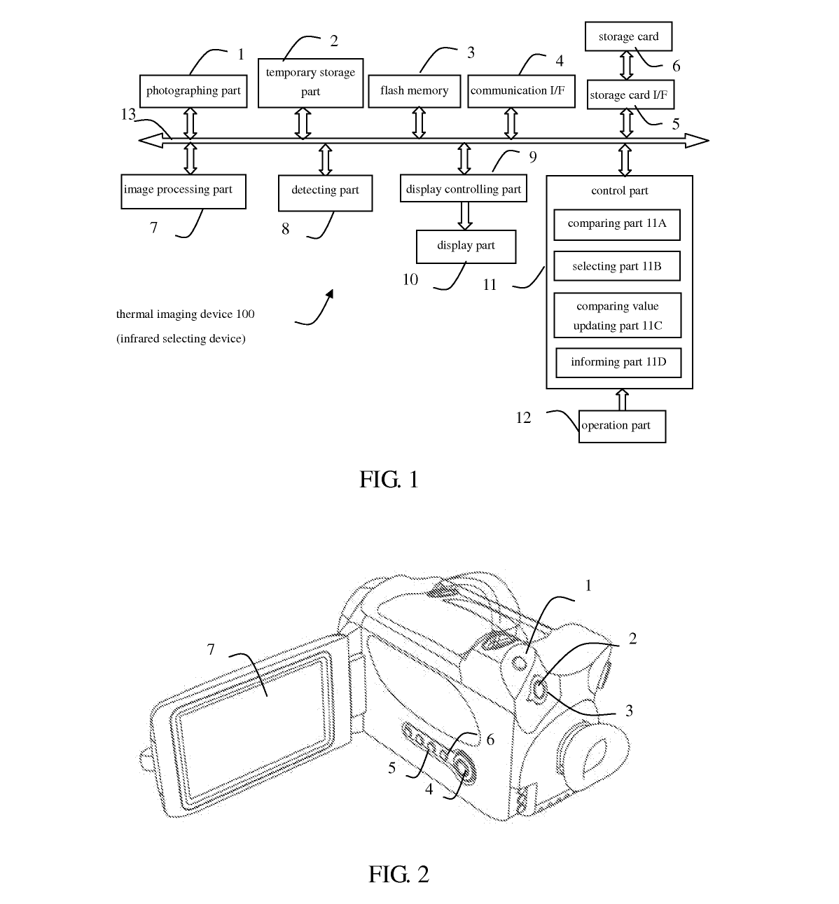

FIG. 1 is a block diagram showing a thermal imaging device 100 as an example of an infrared selecting device in the first embodiment of the invention.

In detail, the thermal imaging device 100 includes a photographing part 1, a temporary storage part 2, a flash memory 3, a communication I/F 4, a storage card I/F 5, a storage card 6, an image processing part 7, a detecting part 8, a display controlling part 9, a display part 10, a control part 11, and an operation part 12. The control part 11 is connected with each other part via a control and data bus 13, and is responsible for overall control of the thermal imaging device 100.

The photographing part 1 includes an optical part, a lens driving part, an infrared detector, and a signal preprocessing circuit, which are not shown. The optical part is composed of infrared optical lenses, and is used for focusing received infrared radiation on the infrared detector. The lens driving part drives the lenses to perform focusing or zooming operation according to a control signal of the control part 10, and the optical part may also be manually regulated. The infrared detector such as a refrigerating or non-refrigerated infrared focal plane detector converts the infrared radiation passing through the optical part to electrical signals. The signal preprocessing circuit, including a sample circuit, an AD conversion circuit, and a timing trigger circuit, performs signal processing such as sampling for the electric signals output from the infrared detector in a specified period. The signals are converted to digital thermal imaging signals by the AD conversion circuit. The thermal imaging signal may be 14-bit or 16-bit binary data (also called thermal imaging AD value data, AD value data for short). In the first embodiment, the photographing part is as an example of an acquiring part for photographing to acquire the thermal imaging data frames.

According to different embodiments of the acquiring part, the called thermal imaging data frame may be a thermal imaging signal (thermal imaging AD value data acquired after AD conversion of the output signal of the infrared detector), image data of infrared thermal images, array data of temperature values, or other data generated based on the thermal imaging signal. In the following text, the thermal imaging data frame may be the thermal imaging signal.

The temporary storage part 2, such as a RAM or DRAM volatile storage, is a buffer storage for temporarily storing the thermal imaging data frames output from the photographing part 1. For example, it may repeat the following processing, that is, to temporarily store the acquired thermal imaging data frames to specified time sets, and to delete the previous data frames to store new thermal imaging data frames when the acquiring part (the photographing part 1) acquires the new frames. Meanwhile, the temporary storage part 2 is a working storage of the image processing part 7, the detecting part 8, and the control part 11, for temporarily storing the processed data. However, the invention is not limited. A storage or register in the processor such as the image processing part 7, the detecting part 8, or the control part 11 may also be defined as a temporary storage medium.

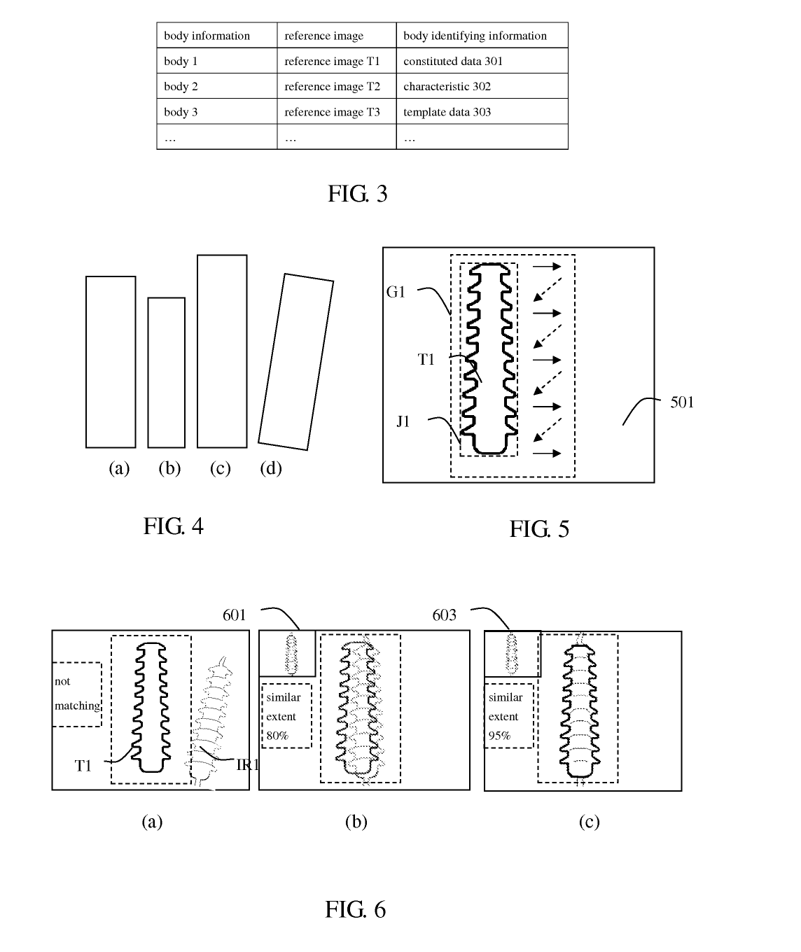

The flash memory 3 stores control programs and different kinds of data used in different control. In the embodiment, as shown in FIG. 3, the data related to the reference image and detection is stored in the storage medium such as the flash memory 3. For example, a database of the body identifying information (table three) may be stored, and body information of each body, the constituted data of the reference image, and the body identifying information corresponds to each other and is stored. In addition, data files with specified formats may store the above information. The constituted data of the reference image may be vector image data, array image data, or the constituted data of the reference image composed of multiple coordinate points data. Template data may be the same with or different from the constituted data of the reference image.

The body information is information related to a body, such as the information representing a place, a type, and a number of the body. In addition, the body information may be the information related to the body, such as an attribution unit, a classified grade (such as a voltage grade or an importance grade), a model, a manufacturer, performance and characteristics, a passed photographing or repairing record, a manufacturing date, or a service life, related to the body. Different applicable body information may be prepared according to different applications.

The communication I/F 4 may be an interface for connecting and exchanging data between the thermal imaging device 100 and an external device according to communication specification such as USB, 1394, or network. The external device may be a personal computer, a server, a PDA (personal digital assistant device), other thermal imaging devices, a visible light photographing device, or a storage device.

The storage card I/F 5 is used as an interface of the storage card 6, and the storage card I/F 5 is connected with the storage card 6. The storage card 6 is as a rewritable non-volatile storage, can be detachably installed in a groove of the main body of the thermal imaging device 100, and can record the data such as the thermal imaging data frames according to the control of a record control part (not shown) of the control part 11.

The image processing part 7 is used for performing specified processing for the thermal imaging data frame acquired by the photographing part 1. For example, as the display timing is achieved every time, it may select and read the frames in each specified time interval from the thermal imaging data frames of the specified time sets temporarily stored in the temporary storage part 2. The image processing part 7 performs processing for converting data to be suitable for displaying or recording, such as modification, interpolation, pseudo-color, synthesis, compression, or decompression. The image processing part 7 may be realized by a DSP, other microprocessors, or a programmable FPGA, or the image processing part 7 may also be integrally formed with the detecting part 8 and the control part 11.

The image processing part 7 is used for performing specified processing for the thermal imaging data frame to acquire the image data of the infrared thermal image. For example, the imaging processing part 7 may perform specified processing such as non-uniformity correction or interpolation for the thermal imaging data frame acquired by the photographing part 1 and then may perform pseudo-color processing for the thermal imaging data frame after the specified processing, to acquire the image data of the infrared thermal image. In one embodiment of the pseudo-color processing, a corresponding range of a pseudo-color plate may be determined according to a range of the thermal imaging data frame AD value or a setting range of the AD value, and the particular color value to which the thermal imaging data frame corresponds in the range of the pseudo-color plate is used as the image data of the corresponding pixel position in the infrared thermal image. The image data acquired after the pseudo-color processing by the image processing part 7 is transferred to the temporary storage part 2 that is used as a buffer storage.

In addition, the image processing part 7 includes a synthesizing part (not shown). The synthesizing part acquires the reference image based on the constituted data of the reference image designated by a reference image designating part 11F and a position parameter set by a position setting part 11G, and synthesizes the reference image and the infrared thermal image generated by the image processing part 7 to generate image data of a synthesized image. In detail, the synthesizing part may synthesize the reference image and the infrared thermal image according to a specified transparency ratio. When the transparency ratio of the reference image is one (for example, the reference image is lines of an edge contour), the reference image is not-transparently synthesized with the infrared thermal image.

The image processing part 7 is used for performing specified processing for the acquired thermal imaging data frame according to the constituted data of the designated reference image and the position parameter set by the position setting part 11G, to generate the infrared thermal image reflecting the reference image.

In addition, the synthesis may be that the pseudo-color processing is performed for the thermal imaging data frame according to the pixel position of the reference image in the infrared thermal image to generate image data reflecting the reference image and the infrared thermal image for display (similar to an overlapping effect), or may be that the pseudo-color processing is performed for the thermal imaging data except the pixel positions of the reference image according to the pixel positions of the reference image in the infrared thermal image to generate the image data for display by combining the image data of the reference image and the infrared thermal image.

Otherwise, the processing (such as different pseudo-color processing) for the thermal imaging data of the reference image at the pixel positions in the thermal imaging data frame may be different from the pseudo-color processing for the thermal imaging data at other pixel positions, thus to generate the image reflecting the reference image. At this condition, the synthesizing part for synthesizing the reference image and the infrared thermal image may be removed from the thermal imaging device 100.

The reference image is displayed with the infrared thermal image together, to facilitate the users photographing the specified body. For example, the reference image may be an image reflecting the morphological character of the specified body, may be with other shapes, such as square or circular, may be an identification image reflecting an expected imaging position where a body thermal image is located in the infrared thermal image, may be the identification image reflecting a detecting area (the detecting area may include one or more detecting windows) in the infrared thermal image, or may be the identification image reflecting an analysis area of an expected body thermal image. Preferably, the reference image is overlapped and displayed with the infrared thermal image according to the specified position parameter (including a position, a size, or a rotating angle).

In addition, the reference image may be displayed at the area outside of the window of the infrared thermal image on the display part. In addition, a thumbnail representing the relation such as the position and dimensional scale of the reference image and the infrared thermal image may be displayed at the area outside of the window of the infrared thermal image on the display part.

The detecting part 8 calculates the correlation degree between the acquired thermal imaging data frame and the body identifying information. Based on the thermal imaging data frame continuously acquired by the acquiring part, the detecting part 8 may perform detection for all of the continuously acquired thermal imaging data frames in turns, or may perform detection for parts of the thermal imaging data frames selected from the continuously acquired thermal imaging data frames, such as the thermal imaging data frames read in a special interval. For example, when the thermal imaging data frame with a correlation degree and/or an evaluating value greater than a comparing value is detected for the first time, the detection is not continued. The detection may be performed or stopped in response to the predetermined operation of a user. Otherwise, the reduced processing is performed before the detection of the thermal imaging data in the read imaging data frame or in the detecting window, thereby reducing the processing load followed by the detection.

The thermal imaging data frame related to detection may be a thermal imaging signal (an AD value), image data of an infrared thermal image, array data of temperature values, or other data acquired according to the thermal imaging signal. For example, based on the control of the control part 11, the detecting part 8 may read the thermal imaging data frame photographed by the photographing part 1 from the temporary storage part 2, or may read data acquired after specified processing by the image processing part for the thermal imaging data frame photographed by the photographing part 1 from the temporary storage part 2 (such as the image data of the infrared thermal image after pseudo-color processing), to perform detection of the correlation degree between the above read data and registered body identifying information.

The thermal imaging data frame is not limited to be photographed and acquired by the photographing part 1. In other examples, it may be acquired according to externally input data. For example, the thermal imaging data frame may be continuously received from other thermal imaging devices via the communication I/F 4 and may be acquired after decompression.

In the first embodiment, the detecting part 8 includes a character registering unit, a detecting window setting unit, and a detecting unit (not shown).

The character registering unit is used for registering the body identifying information related to the calculation of the correlation degree. For example, the body identifying information may be registered according to the body identifying information prestored in the storage medium. For example, according to the body identifying information related to the body information selected by users, the body identifying information for the calculation of the correlation degree may be registered. In addition, the users may designate the body identifying information. For example, the body identifying information (such as template data or extracted characteristics) may be acquired by designating a body area in a displayed image. The registered body identifying information may be stored at a specified position of the temporary storage part 2, or may be differentiated from other stored body identifying information during storing.

The body identifying information may be template data (such as template images) for template matching. In addition, the body identifying information may be characteristics described by parameters. The characteristics (such as points, lines, or planes) may be a value determined by a state of pixels contained in a detecting window, such as a ratio of specified pixels in a specified detecting window, an average value of the pixel values, a center point or an area of a contour of a specified body. For example, for a body 1 in table three, the body identifying information is template data 301, and for a body 2 in table three, the body identifying information is a characteristic 302. In detailed application, one type of the body identifying information or a combination thereof may be used according to conditions.

The detecting window setting unit is used for setting the detecting window. For example, according to the detecting area (such as G1 in FIG. 5) in a certain range, a plurality of the detecting windows are set in the detecting area G1 (such as, the parameters of the detecting windows may be predetermined according to the quality requirement), the detecting windows may be the detecting windows with different dimensions, and may be the inclined detecting window. In FIG. 4, FIG. 4 (a) shows a standard detecting window, FIG. 4 (b) shows a detecting window with a reduced dimension, FIG. 4 (c) shows a detecting window with an enlarged dimension, and FIG. 4 (d) shows a detecting window inclined according to a specified angle. To be equal to the dimension of the detecting window, the template image may be used in a reduced, enlarged or inclined state, or the template image with the dimension equal to the window dimension may be prepared and stored for use. In addition, the thermal imaging data in the detecting window may be used in a reduced, enlarged, or inclined state, to correspond to the template image. The detecting window is not limited to be square, or may be in other shapes, which may be determined according to the shape of the template.

The detecting area may be set according to photographing customs of the users, may be prestored, such as, the detecting area related to the body information, may be generated according to the position where the specified body thermal imaging is detected at the last time, or may be a range of the thermal imaging data frame without setting the specified detecting area. Several detecting windows may be set according to the positions and dimensions designated by the users. In addition, the several detecting windows are not necessary, and only one detecting window may be set.

In the infrared detection field, for example, there are a large amount of devices with different names and similar shapes in a substation. To avoid misleading the users and incorrectly photographing, the detecting area may be set preferably. As the identification of the detecting area is overlapped and displayed on the infrared thermal image, the users may understand the approximate position and dimension of the photographed specified body thermal image, thereby providing the photographing reference and accelerating the detecting speed. However, the detecting area may not be shown.

The detecting unit acquires a correlation degree value for evaluating the similar extent according to the registered body identifying information, based on the acquired thermal imaging data frame and the thermal imaging data in the detecting window set by the detecting window setting unit. When there are several detecting windows, the detected maximum correlation degree value may be as the correlation degree value of the thermal imaging data frame.

The detection of the detecting part 8 may be based on template matching, and the detecting part 8 may calculate and compare the correlation degree based on the thermal imaging data in the detecting window and the template image. For example, the detecting unit may calculate a sum of the difference between the pixel of the position of the infrared thermal image in the detecting window and the pixel of the corresponding position of the infrared thermal image that is as the template image, and the smaller the calculated sum of the difference is, the greater the correlation degree is. For example, the detection may be based on the matching of the extracted characteristic. The correlation degree may be determined by comparing the characteristic of the thermal imaging data in the detecting window and the template image. For example, the closer a ratio of the specified pixels extracted from the body thermal image in the detecting window and a ratio of the specified pixels in the template image is, the greater the correlation degree is.

The detection of the detecting part 8 may be based on the characteristics described by parameters. The detecting part 8 performs specified calculation to acquire the characteristic of the thermal imaging data in the detecting window, which is compared with a base value (the body identifying information) of the characteristic, thus to acquire the correlation degree value. For example, the base value of the characteristic is a pixel ratio of specified pixel values. The detecting unit calculates the pixel ratio of the specified pixel values in the thermal imaging data and compares the pixel ratio and the base value, to acquire the correlation degree value therebetween.

Preferably, a contour image is as the matched template. The detecting part 8 may perform the following processing to calculate the correlation degree. First, the detecting part 8 extracts the thermal imaging data in the detecting window and performs binaryzation for the read thermal imaging data in the detecting window according to a specified threshold of the AD value. Then, a connected image of the connected pixels with the specified pixel value (1 or 0) is extracted from the binaryzation image. Then, if the size of the connected image is in a predetermined range is determined. If the size of the connected image is in the predetermined range, the comparison is performed between the extracted connected image and the registered template, such as, calculating a sum of the ratio of the overlapping area therebetween in the respective total area, thereby acquiring the correlation degree between the extracted thermal imaging data and the template.

In one example of detection, in FIG. 5, the detecting part 8 detects in a specified detecting area G1 of a thermal imaging data frame 501 by moving a window J1 from the left-upper corner to the right-lower corner, cuts the thermal imaging data in the window, and detects the correlation degree of the cut thermal imaging data and a template image T1. In detail, the window J1 gradually moves from the left end to the right end via a specified value as the window displacement (such as one pixel), is set to return to the left end and move downwards when achieving the right end, and moves rightwards gradually afterwards. To accurately detect the body, a changing range of a dimension, displacement, and inclined angle of the window is defined in advance. For example, the changing range of the window dimension may be from 150×50 pixels to 120×40 pixels, the changing range of the window displacement may be from 10 pixels to one pixel, and the changing range of the inclined angle of the window may be from 0° to 10° based on a center point. The detecting part 8 gradually changes the window dimension at each time of five pixels, changes the window displacement at each time of one pixel, and changes the inclined angle of the window at each time of 2°. The detecting part 8 calculates the correlation degree of the template image T1 and the thermal imaging data frame 501, and selects the correlation degree value acquired from the detecting window with the maximum correlation degree value as the correlation degree value corresponding to the thermal imaging data frame 501 after the detection of all detecting windows.

Different methods may be used for calculating the correlation degree of the thermal imaging data frame based on the body identifying information, and the above processing method is just an example.

The display controlling part 9 is used for displaying the image data stored in the temporary storage part 2 on the display part 10. For example, in a standby photographing mode, the infrared thermal images generated by the thermal imaging data frames acquired by photographing are continuously displayed. In a replay mode, the infrared thermal image read and expanded from the storage card 6 is displayed. In addition, different setting information may be displayed. In detail, the display controlling part 9 includes a VRAM, a VRAM control unit, and a signal generating unit (not shown). Further, under the control of the control part 10, the signal generating unit regularly reads the image data (the image data read from the temporary storage part 2 and stored in the VRAM) from the VRAM, and generates video signals to be displayed on the display part 10. In the thermal imaging device 100, the display part 10 may be a liquid display device. However, the invention is not limited thereto. The display part 10 may further be other display devices connected with the thermal imaging device 100, and the thermal imaging device 100 may not include the display part in itself. At that moment, the display controlling part 9 may be an example of an image output part.

In addition, in the first embodiment, based on the control of an informing part 11D, the display part 10 is used for displaying the informing information. For example, characters and images may be used for warning, such as displaying the maximum correlation degree or displaying the infrared thermal image acquired according to the thermal imaging data frame with the maximum correlation degree, or the informing may be followed by changes of a transparency ratio, a color, a dimension, a line type, a twinkling state, luminance, or a box of the characters or the images.

The informing mode may continue specified time. In addition, a vibrating part, an indicating light (not shown), an analysis part (not shown), or a diagnosis part (not shown) may be disposed in the thermal imaging device 100. When the thermal imaging data frame with the maximum correlation degree is detected, the indicating light may generate light changes, the vibrating device may generate vibration, the analysis part may perform analysis and display an analysis result, the diagnosis part may perform diagnosis and display a diagnosis result, or a combination of the above modes may be used for informing, as long as the users can be informed.

The control part 11 controls the whole action of the thermal imaging device 100, and the flash memory 3 stores control programs and different kinds of data used in different control. The control part 11 may be realized through a CPU, an MPU, a SOC, or a programmable FPGA. In the embodiment, the control part 11 and the display part 10 may be as a body information selecting part for selecting the body information.

In addition, the control part 11 includes a comparing part 11A for comparing the specified information acquired by the detecting part 8 and/or the evaluating value acquired according to the acquired specified information and a specified comparing value. The specified information at least includes a position, a dimension, an inclined angle, a correlation degree value of a specified body thermal image, or a combination thereof. In the first embodiment, the correlation degree value of the thermal imaging data frame acquired by the detecting part 8 is compared with the comparing value of the correlation degree. The comparing value of the correlation degree may be a judging value of the correlation degree that is prepared in advance (such as, the comparing value corresponding to the body identifying information and being stored in table three, or the comparing value set by users). When the correlation degree is greater than the comparing value, the specified body thermal image in the thermal imaging data frame is determined. Otherwise, the comparing value of the correlation degree may not be prepared in advance, and it may be acquired according to the correlation degree value of the thermal imaging data frame. For example, the correlation degree value acquired at the first time may be as the comparing value of the correlation degree during subsequent comparison, and when the correlation degree greater than the comparing value is detected, the comparing value is updated.

In addition, the control part 11 includes a selecting part 11B for selecting the special information related to the specified thermal imaging data frame based on the comparing result of the comparing part 11A. The selected special information may be used for the subsequent specified processing such as analyzing, recording, and informing.

The special information related to the specified thermal imaging data frame may be the special information related to one or more of the thermal imaging data frames stored in the temporary storage part 2. For example, based on the comparing result of the comparing part 11A, the special information related to the thermal imaging data frame with the maximum correlation degree may be selected. However, the special information is not limited to be related to the thermal imaging data frame with the detected maximum correlation degree. The special information may be related to the frame before or after the frame with the detected maximum correlation degree, the frame acquired by calculation of the several frames, or the thermal imaging data frame corresponding to the correlation degree that is detected to be greater than the specified comparing value at the earliest time. The special information related to the several thermal imaging data frames may be selected. For example, the special information related to three thermal imaging data frames with the correlation degree at the first, second, and third sequence may be selected, or the special information related to the thermal imaging data frames with the same correlation degree may be selected.

Otherwise, the specified thermal imaging data frame may be one or more of the thermal imaging data frames photographed by the photographing part 1 and stored in the temporary storage part 2 when the thermal imaging data frame with the maximum correlation degree is detected, or may be one or more of the thermal imaging data frames photographed by the photographing part 1 and stored in the temporary storage part 2 after the thermal imaging data frame with the maximum correlation degree is detected.

The special information may be the thermal imaging data frame selected from the several thermal imaging data frames stored in the temporary storage part 2, the data acquired after specified processing for the thermal imaging data frame selected from the several thermal imaging data frames, the specified information acquired by detection, the evaluating value acquired according to the specified information acquired by detection, the indicating information generated according to the acquired specified information and/or the evaluating value, or a combination thereof.

The data acquired after the specified processing for the thermal imaging data frame selected from the several thermal imaging data frames may be the data acquired after the specified processing for the selected thermal imaging data frame, the specified body thermal image extracted from the thermal imaging data frame, the image data of the generated infrared thermal image, or the analysis value converted by the thermal imaging data frame, such as an array of temperature values.

The specified information acquired by detection may at least include a position, a dimension, an inclined angle, a correlation degree value of a specified body thermal image, or a combination thereof.

The evaluating value acquired according to the specified information acquired by detection may be the evaluating value acquired by weighting the specified information acquired by detection according to weighted coefficients, or may be the evaluating value for evaluating the quality of the thermal image acquired according to a comparing table of the specified information and the evaluating value.

The indicating information generated according to the specified information acquired by detection and/or the evaluating value may be percentage information facilitating understanding of the users, which is converted from the acquired specified information and/or the evaluating value.

The selecting part 11B controls to remain the selected special information or not. The remained special information is remained at the specified area of the temporary storage part 2, or may be remained (stored) in a storage medium such as the flash memory 3. In the following text, the selecting part 11B remains the special information, such as the thermal imaging data frame, at the specified area of the temporary storage part 2.

The selecting part 11B may always remain the selected special information or remain at a specified condition. For example, the currently selected special information may be remained for specified time, the current special information may be remained until the thermal imaging data frame with the greater correlation degree is detected, the selected special information may be remained until the body identifying information for detection and comparison or the selected body information is changed, or the special information may be remained or not according to the indication of the users (such as the users may select certain special information displayed on the display part for remaining). In addition, the special information may not be remained. For example, it may be transferred to other external devices via the communication I/F 4, or may be detected after other processing such as informing.

Further, the selecting part 11B is used for updating the special information remained in the temporary storage part 2 to the special information subsequently selected by the selecting part 11B according to a specified condition. The specified condition may be specified time, a condition that a specified amount of the thermal imaging data frames are detected, the comparing result of the comparing part 11A (such as the condition that the correlation degree greater than the correlation degree of the remained thermal imaging data frame is acquired), or the indication of the users. In addition, the previously remained special information may be still remained.

In the first embodiment, based on the comparing result of the comparing part 11A, the selecting part 11B controls to select, remain, and update the special information. When the detecting part 8 detects that the correlation degree value of the specified body thermal image is greater than the comparing value of the correlation degree, the special information such as the correlation degree value and the corresponding thermal imaging data frame may be selected to be remained in the storage medium such as the temporary storage part 2. When there is the previous special information, such as the correlation degree value and the corresponding thermal imaging data frame, the previous special information may be replaced, and the current special information may be replaced until the thermal imaging data frame with the greater correlation degree is detected subsequently (or the specified amount of the thermal imaging data frames with the greater correlation degree may be remained). Thus, the special information such as the maximum correlation degree value and the corresponding thermal imaging data frame may be remained. In addition, the previously remained special information may be still remained.

The selecting part 11B is not limited to select the special information related to the best (such as the maximum correlation degree) thermal imaging data frame, may select the special information related to the second best one, the special information related to the frame acquired by calculation of the several frames, or the special information related to the several thermal imaging data frames, such as the special information related to three stored (remained) thermal imaging data frames with the first, second, and third correlation degree, or the special information related to three thermal imaging data frames with the same correlation degree.

In addition, the control part 11 includes a comparing value updating part 11C for updating the comparing value according to the specified condition. Further, when the comparing value is updated, the comparing part 11A compares the specified information acquired by the detecting part 8 and/or the evaluating value acquired according to the acquired specified information with the updated comparing value.

The comparing value may be updated according to the indication of the users, the comparing result of the comparing part 11A, or the specified time.

According to the comparing result of the comparing part 11A, the comparing value is updated. The several comparing values prepared in advance may be updated in turns. For example, three comparing values of the correlation degree are prepared, when the detecting part 8 detects that the correlation degree is greater than the first comparing value, the comparing value is updated to the second comparing value, and when the correlation degree greater than the second comparing value is detected, the comparing value is updated to the third comparing value.

According to the comparing result of the comparing part 11A, the comparing value is updated. The prepared comparing value may be updated, according to the specified information acquired by detection. For example, the detecting part 8 detects to acquire the correlation degree value, and when the correlation degree value is greater than the comparing value of the correlation degree prepared in advance, the acquired correlation degree value replaces the comparing value.

According to the comparing result of the comparing part 11A, the comparing value is updated. According to the specified information acquired by detection, the comparing value may be updated by itself. There is no comparing value prepared in advance. For example, the detecting part 8 detects to acquire the correlation degree value, and when the correlation degree value is greater than the comparing value of the correlation degree (for example, the previously detected maximum correlation degree is as the comparing value), the acquired correlation degree value replaces the comparing value.

Preferably, the control part 11 includes an informing part 11D for informing based on the special information related to the thermal imaging data frame selected and specified by the selecting part 11B and/or the updating information of the comparing value. For example, based on the special information related to the specified thermal imaging data frame selected and remained by the selecting part 11B, the informing information acquired according to the special information is displayed with the infrared thermal image acquired according to the thermal imaging data frame continuously acquired by the acquiring part and the reference image together. Preferably, the informing information acquired according to the currently selected special information is displayed with the infrared thermal image acquired according to the thermal imaging data frame continuously acquired by the acquiring part and the reference image together. For example, the infrared thermal image (such as reduced) acquired according to the currently selected and remained thermal imaging data frame may be displayed with the infrared thermal image continuously acquired by the photographing part 1 and the reference image. In addition, other informing information may be displayed together or singly, such as the correlation degree value or the evaluating value. In addition, the dynamic infrared thermal image may be switched to a frozen image of the thermal imaging data frame.

When the selecting part 11B selects and remains the special information related to the thermal imaging data frames, the informing part 11D may inform one or more thereof. For example, the infrared thermal image (such as reduced) acquired according to the thermal imaging data frames may be displayed with the infrared thermal image continuously acquired by the photographing part 1 together.

The informing information is acquired according to the special information related to the thermal imaging data frame selected and specified by the selecting part 11B. For example, the correlation degree value may be converted into the information indicating the similar extent and facilitating understanding of the users. For example, according to a specified comparing table of the correlation degree value and percentages or a calculating mode (such as, the percentage value of the correlation degree may be acquired by dividing the sum of the ratio of the overlapping area between the extracted contour of the specified body and the contour T1 in the respective total area by 200%), the correlation degree value is converted into a percentage value. Otherwise, the calculated correlation degree value may be directly displayed, or the sum of the difference of the pixel values may be directly displayed. When the specified comparing value (the judging value representing whether the specified body thermal image matches the body identifying information) representing whether the specified body thermal image is detected is not compared, the displayed correlation degree information may not represent whether the specified body thermal image is detected (matched). To facilitate description, in the following text, the correlation degree value, the evaluating value, and the comparing value converting into the percentage value is taken for example. However, the percentage value is not necessary to be converted.

The informing mode may continue specified time. Based on the control of the informing part 11D, the displayed content generated by the display part 10 may be changed, a vibrating device in the thermal imaging device 100 may generate vibration, an indicating light may generate light changes, a sound part may generate sound, an analysis part may perform analysis (and allows the display part 10 to display an analysis result), a diagnosis part may perform diagnosis (and allows the display part 10 to display a diagnosis result), the reference image may be twinkled or with the changed color, the pseudo color of the infrared thermal image may be changed, or a combination of the above modes may be used for informing, as long as the users can be informed.

In addition, the control part 11 includes a record part 11E (not shown) for recording the thermal imaging data frame selected and remained by the selecting part 11B in the temporary storage part 2 to the storage card 8, in response to the specified record indication. For example, in response to the indication such as selection of the informed thermal imaging data frame by the users, or timing automatic record indication, the thermal imaging data frame may be record to the storage card 8.

In addition, the control part 11 includes a reference image designating part 11F (not shown) for designating the constituted data of the reference image that is displayed with the infrared thermal image together. For example, based on the constituted data (array data and/or vector data) of the reference image related to the body information stored in the storage medium, according to the body information selected by the users, the constituted data of the reference image related to the body information is designated. The constituted data of the reference image is not limited to be acquired according to the body information, may be acquired according to the thermal imaging file selected from the storage medium, or may be designated according to the default configuration of the thermal imaging device 100, such as data of a defaulted detecting area. In addition, an area in the infrared thermal image displayed on the display part may be designated, and the infrared thermal image of the area may be as the reference image.

In addition, the control part 11 includes a position setting part 11G (not shown) for setting the position parameter (a position, a dimension, or a rotating angle) of the reference image located in the display part. Preferably, the position setting part 11G is used for setting the position parameter of the reference image located in the infrared thermal image. For example, according to a specified self-adaptive display area in the infrared thermal image and a position parameter for maximum centered display of the calculated reference image in the self-adaptive area, the position parameter of the reference image located in the infrared thermal image is set. For example, according to the parameters (such as reflecting the position parameter in the infrared thermal image) attached by the reference image, the position parameter of the reference image located in the infrared thermal image may be set. Otherwise, according to the configuration (centered, an original dimension) of the thermal imaging device 100, the position parameter of the reference image located in the infrared thermal image may be set. Otherwise, the position parameter may be set according to the position parameter input by a user.

The operation part 12 is used for a user to perform operation such as indicating operation or inputting setting information. The control part 11 executes the corresponding program according to an operation signal of the operation part 12. As shown in FIG. 2, the operation part 12 may include a record key 1, a focusing key 2, an enter key 3, a replay key 4, a menu key 5, and a direction key 6. In addition, a touch screen 7 or a phonic part (not shown) may be used for realizing related operation.

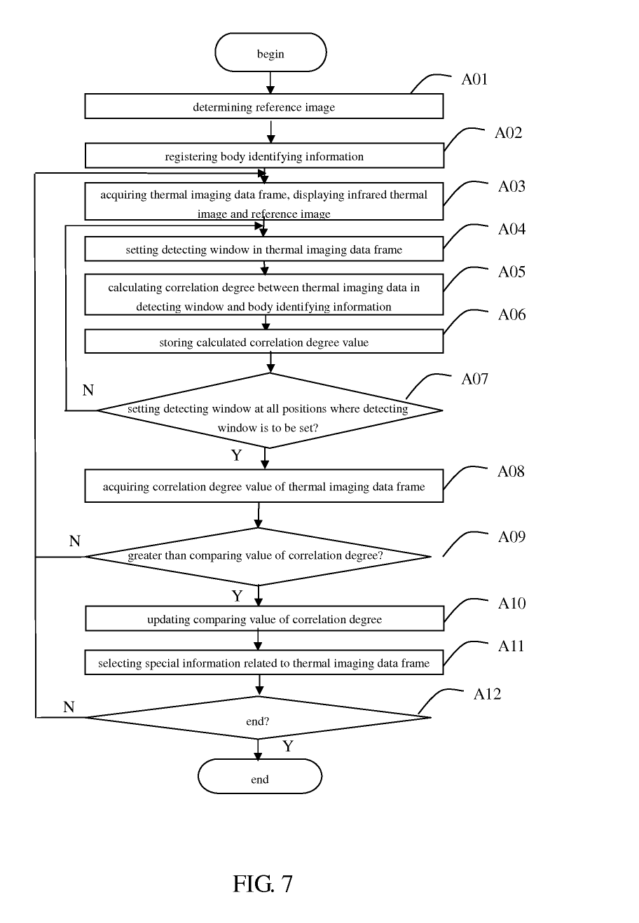

Referring to FIG. 6, the changes of the display interface during photographing are described. Referring to FIG. 7, the control flows of the detecting mode of the thermal imaging device 100 are described. The applied scene may be that a user may photograph the bodies in a substation via a handheld thermal imaging device 100. Based on the control programs and different data used in each control stored in the flash memory 3, the control part 11 controls the whole action of the thermal imaging device 100 and execution of multiple mode processing. When the power is on, the interior circuits of the control part 11 are initialized, and then a standby photographing mode is entered, that is, the photographing part 1 acquires thermal imaging data, the image processing part 7 performs specified processing for the thermal imaging data acquired by the photographing part 1 to acquire the image data that is to be stored in the temporary storage part 2, and the display part 10 continuously displays the infrared thermal image in a dynamic image mode. In the state, the control part 10 continuously monitors whether other modes are switched according to the predetermined operation or shutdown operation is performed. If yes, the corresponding processing control is performed. The detecting mode includes the following control steps.

In step A01, a reference image is determined.

In a standby photographing mode, the display part 10 displays the dynamic infrared thermal image. In the past, the morphological character of a specified body thermal image IR1 and the imaging position, dimension, and angle of the thermal image in the infrared thermal image confuse the user. To ensure the photographing quality, the detecting mode is selected via the predetermined operation of the operation part 12. Based on the table three stored in the flash memory 3, the control part 11 allows the body indicating information generated by the body information to be displayed on the display part 10. When a user selects a “body 1” displayed on the display part 10 via the operation part 12 according to the “body 1” at the scene, according to the selection of the user, the reference image designating part 11F determines the reference image T1, reads the constituted data of the reference image T1 from the flash memory 3, and transfers the constituted data to the temporary storage part 2. Further, the position setting part 11G sets the position parameter (a position and a dimension) of the reference image T1 located in the infrared thermal image. For example, according to the attached position parameter, the position parameter of the reference image T1 located in the infrared thermal image is set. In addition, the position parameter of the reference image T1 located in the infrared thermal image may be determined according to a specified self-adaptive display area or the position parameter designated by the user.

In step A02, the character registering unit registers the body identifying information. According to the “body 1” selected by the user, the character registering unit determines the body identifying information for matching. In the embodiment, the reference image T1 is supposed as the template image for calculating the correlation degree (in addition, the template data 301 read from the flash memory 3 may be as the body identifying information for calculating the correlation degree).

In step A03, the thermal imaging data frame is acquired, and the thermal imaging data frame photographed by the photographing part 1 is transferred to the temporary storage part 2. The image processing part 7 performs specified processing such as pseudo-color conversion for the acquired thermal imaging data frame, to acquire the image data of the infrared thermal image, and the synthesizing part 7A synthesizes (overlap) the image data of the reference image T1 acquired by the determined constituted data according to the set specified dimension and the image data of the generated infrared thermal image according to the set specified position. The synthesized image data is stored to the temporary storage part 2. Then, the display controlling part 9 allows the synthesized image to be displayed on the display part 10. As shown in FIG. 6 (a), there is difference of the position and dimension between the body thermal image IR1 and the contour image T1. The user can photograph the body thermal image IR1 according to the reference image. If the specified body thermal image is not detected in the subsequent process, the reference image may be continuously synthesized with the newly acquired thermal imaging data frame, thus to continuously display the dynamic synthesized image.

Then, in step A04, the thermal imaging data frame instantly photographed by the photographing part 1 stored in the temporary storage part 2 is read. The detecting window setting unit sets a detecting window. For example, the detecting window may be first set at the left-upper corner of the specified detecting area G1.

In step A05, the calculation of the correlation degree between the thermal image in the detecting window and the body identifying information is performed.

The detecting part 8 extracts the image data in the detecting window based on the detecting window set by the detecting window setting unit, and calculates the correlation degree therebetween according to the template registered by the character registering unit. For example, according to the comparison of the contour of the specified body thermal image extracted from the thermal imaging data in the detecting window and the contour of the contour image T1, the sum of the ratio of the overlapping area therebetween in the respective total area may be calculated, thereby acquiring the correlation degree value.

Further, in step A06, the acquired correlation degree value is stored.

In step A07, the detecting part 8 determines if the calculation of the correlation degree for all detecting windows is performed when the detecting window is set in the thermal imaging data frame. If there is a surplus area without calculation of the correlation degree (no in the step A07), return to the step A04. The detecting window setting unit allows the position of the detecting window to move along a predetermined direction for specified pixels, and sets the position as the next position of the detecting window. The subsequent processing is repeated.

In addition, when the frame similar to the template is found from the thermal imaging data frame, the similar detection may also be performed for the detecting window acquired after the detecting window J1 is enlarged, reduced, and inclined with a specified angle.

If the calculation of the correlation degree is performed for all detecting windows set in the thermal imaging data frame (yes in the step A07), in step A08, the detected maximum correlation degree value (or the position parameter of the corresponding detecting window) is remained at the specified area of the temporary storage part 2.

In step A09, the comparing value of the correlation degree is compared with the correlation degree.

If the correlation degree is smaller than the comparing value, the similar extent between the specified body thermal image in the currently detected thermal imaging data frame and the contour image T1 is not better than the previously acquired comparing value, return to the step A03 and repeat the following processing, or jump to step A12 and return to the step A03 if not exited. In the embodiment, the users may change the photographing position and adjust the photographing distance, imaging position, and angle between the optical part of the thermal imaging device 100 and the specified body thermal image, and the subsequent processing may be repeated with the adjusting operation of the users. When the correlation degree is greater than the comparing value of the correlation degree in the step A09, enter into step A10.

The comparing value of the correlation degree may be the original comparing value of the correlation degree prepared in advance (for example, the judging value for judging whether the specified body thermal image matches the body identifying information is as the original comparing value of the correlation degree). When the correlation degree value acquired by detection is greater than the judging value, representing that the correlation degree of the detected specified body thermal image is greater than the prepared judging value, the judging value is replaced by the comparing value acquired according to the currently detected correlation degree value as the comparing value of the correlation degree for subsequent detection, to determine if the specified body thermal image with the greater correlation degree is acquired. In the embodiment, the original comparing value of the correlation degree in the thermal imaging device 100 is 72%, and the original comparing value is the judging value for judging if the specified body thermal image is detected. If the acquired correlation degree of the thermal imaging data frame is smaller than the comparing value, the specified body thermal image is not detected in the thermal imaging data frame. When a user fails to acquire the informing information related to the selected special information via repeated photographing, it means that the incorrect body is photographed. In FIG. 6 (a), since the detected correlation degree value is smaller than 72%, the informing information is not displayed, and the words of “not matching” is displayed.

In addition, the comparing value of the correlation degree may not be prepared in advance. For example, the firstly detected correlation degree value of the thermal imaging data frame may be as the comparing value of the correlation degree for detecting the subsequent thermal imaging data frame, and when the correlation degree greater than the comparing value is detected subsequently, the comparing value may be replaced.

In the embodiment, the correlation degree is evaluated according to if the correlation degree is greater than the comparing value. However, the correlation degree may also be evaluated according to if the correlation degree is smaller than or closer to the comparing value (the judging value prepared in advance). Further, the comparing value may be the correlation degree value, or the value acquired after conversion of the correlation degree value (correspondingly, the correlation degree value acquired by detection may be converted before being compared with the comparing value).

In step A10, the comparing value updating part 11C updates the comparing value of the correlation degree according to the detected maximum correlation degree value. Further, the updated comparing value is as the comparing value of the correlation degree for subsequent detection of the thermal imaging data frame. For example, when the detected maximum correlation degree of the thermal imaging data frame is 80%, the previous comparing value 72% is replaced.

In step A11, the selecting part 11B remains the special information such as the thermal imaging data frame corresponding to the detected maximum correlation degree value at the specified area of the temporary storage part 2, which replaces the previous special information (if there is the previous special information). In addition, the special information related to the specified amount of the thermal imaging data frames may be remained. For example, the special information such as three thermal imaging data frames with the maximum correlation degree and the corresponding correlation degree values may be remained.

Further, the special information related to the selected thermal imaging data frame with the maximum correlation degree is informed.

For example, the image acquired according to the thermal imaging data frame may be displayed with the dynamic infrared thermal image generated according to the subsequently acquired thermal imaging data frame and the reference image together. Further, the remained special information is always remained in the temporary storage part 2 until the special information is selected by the selecting part 11B again or the indication of the user is received.

In FIG. 6(b), this invention is not limited to display a reduced infrared thermal image 601, or other modes may be used. For example, the correlation degree value acquired by calculation may be directly displayed (in one example, the sum of difference of pixel values may be directly displayed). In addition, the display of the dynamic infrared thermal image is switched to the display of the frozen image of the thermal imaging data frame. Preferably, the area (or the position parameter of the body) of the detecting window with the detected maximum correlation degree may be informed. For example, an identification of the position of the body thermal image with the maximum correlation degree may be shown in the frozen infrared thermal image. Otherwise, the display of the dynamic infrared thermal image is switched to the display of the frozen image of the thermal imaging data frame, and then in response to the indication of the user, the display of the dynamic infrared thermal image is switched back, or the display of the image acquired according to the thermal imaging data frame, the dynamic infrared thermal image generated according to the subsequently acquired thermal imaging data frame, and the reference image is switched. In addition, the infrared thermal image acquired according to the thermal imaging data frame may not be displayed, and the indicating information is displayed, or different modes capable of being sensed by the users, such as vibration or twinkling of the indicating light, may be used. Further, when the selecting part 11B is configured to indicate to remain the thermal imaging data frames, the dynamic infrared thermal image and the reduced infrared thermal image acquired according to the remained thermal imaging data frames may be displayed together, or may be displayed in sequence according to the correlation degree.

When the comparing value (the judging value for determining if the specified body thermal image matches the body identifying information) for determining if there is the specified body thermal image is not compared, the displayed correlation degree information may not represent whether the specified body thermal image is detected.

Further, the invention is not limited to inform the special information selected by the selecting part. The updating event of the comparing value or the comparing value may be informed.

In step A12, if the detecting mode is exited is determined. If no, return to the step A03, and repeat the subsequent processing. At that moment, since the comparing value of the correlation degree is updated in the step A11, the subsequently photographed thermal imaging data frame is compared with the updated comparing value of the correlation degree, and when the comparing value of the correlation degree is smaller, the remained special information is replaced.

In one example of the informing mode, since the original comparing value of the correlation degree is 72%, in FIG. 6(a), when the detected correlation degree value is smaller than 72%, the special information for informing is not displayed, and the words of “not matching” may be displayed. In FIG. 6(b), during photographing, when the maximum correlation degree detected at the first time is 80% (the indicating information converted by the sum of the ratios of the overlapping area), the correlation degree value is as the comparing value of the correlation degree for subsequent comparison (replacing the comparing value of the correlation degree 72%), and the reduced infrared thermal image 601 acquired by the selected thermal imaging data frame is displayed with the dynamic infrared thermal image and the reference image. When the subsequently detected maximum correlation degree value is greater than 80%, in FIG. 6(c), the correlation degree value is 95%, replacing the comparing value of the correlation degree 80%, being as the new comparing value of the correlation degree (95%). The selecting part 11B remains the special information such as the thermal imaging data frame corresponding to the detected maximum correlation degree value 95% at the specified area of the temporary storage part 2, allows the previous special information to be replaced, allows a reduced infrared thermal image 603 acquired according to the selected thermal imaging data frame to be displayed with the dynamic infrared thermal image and the reference image together. And so on and so forth, when the detected correlation degree value is 95%, in FIG. 6(c), if the user is satisfied, the aiming photographing for the body may be stopped. Since the thermal imaging data frame is remained in the storage medium such as the temporary storage part 2, the subsequent processing or operation such as analysis or storage may be facilitated. At that moment, if the user presses the record key, the thermal imaging data frame corresponding to the infrared thermal image 603 may be record to the storage card 8 after specified processing (such as decompression). Further, even if the indicating information or the infrared thermal image is not displayed, such as the indicating light is twinkled, since the thermal imaging data frame is remained in the storage medium such as the temporary storage part 2, the processing such as display or record may be performed when the user presses the enter key or the record key.

Further, the information of updating the comparing value may be informed, and the information of the thermal imaging data frame may not be informed.

Further, in some conditions, if the specified body thermal image is detected is not limited to be according to the comparison between the correlation degree value and the comparing value of the correlation degree, or may be according to a comparing result between the specified information acquired by detection and/or the evaluating value acquired according to the specified information and the predetermined comparing value.

According to the above, in the embodiment, the reference image is displayed to assist photographing. When the thermal imaging data frame with the correlation degree greater than the comparing value is detected, the thermal imaging data frame is selected or further informed, and once the correlation degree greater than the previous comparing value of the correlation degree is detected subsequently, the comparing value and the informed information is continuously updated, thereby greatly reducing the operation difficulty of visual aiming, greatly reducing the photographing physical strength, and improving the quality of the finally acquired thermal imaging data frame. The common users can easily grasp the photographing skill Any product where the embodiment of the invention is applied may not be necessary to achieve all of the above advantages at the same time.

Further, in the infrared detection field, since the difference of the position, dimension, and inclined angle of the specified body thermal image in the infrared thermal image corresponds to the different photographing quality, even if the correlation degree is greater, as the above parameter is not ideal, the quality of the acquired thermal imaging data frame may not be better. Therefore, preferably, as the specified information such as the position, dimension, inclined angle, or correlation degree value of the specified body thermal image located in the thermal imaging data frame is considered, the evaluating value (may be the evaluating value acquired according to one or several specified information) acquired according to the specified information is compared with the specified comparing value, which is as the factor for selecting the specified thermal imaging data frame and informing, to indicate the user to pay attention to the photographing quality, or to select the thermal imaging data frame with the best photographing quality for subsequent processing.

### Embodiment Two

The difference between the first embodiment and the second embodiment is that the detecting part 8 of the thermal imaging device 100 detects the thermal imaging data frame and the specified information related to the specified body thermal image based on the thermal imaging data frames continuously acquired by the acquiring part (the photographing part 1), the control part 11 includes an auxiliary information acquiring part (not shown) for acquiring auxiliary information, the comparing part 11A is used for comparing the specified information acquired by the detecting part, the auxiliary information acquired by the auxiliary information acquiring part, the evaluating value acquired according to the specified information acquired by the detecting part, the evaluating value acquired according to the auxiliary information acquired by the auxiliary information acquiring part, the evaluating value acquired according to the specified information acquired by the detecting part and the auxiliary information acquired by the auxiliary information acquiring part, or a combination thereof, with corresponding one or more comparing value, the selecting part 11B selects the special information related to the specified thermal imaging data frame based on a comparing result of the comparing part 11A, when there is several comparison, according to different comparing results, in different embodiments, the informed special information may be the special information related one or more thermal imaging data frame, and the informing part 11D performs informing based on the special information related to the thermal imaging data frame selected and specified by the selecting part 11B. The comparing value updating part 11C is used for updating the comparing value.

The specified information at least includes a position, a dimension, an inclined angle, a correlation degree value of a specified body thermal image, or a combination thereof.

In the infrared detection field, since the difference of the position, dimension, and inclined angle of the specified body thermal image in the infrared thermal image corresponds to the different photographing quality, even if the correlation degree is greater, as the above parameter is not ideal, the quality of the acquired thermal imaging data frame may not be better. Therefore, the factor such as the position, dimension, and inclined angle of the specified body thermal image located in the thermal imaging data frame may be considered as the factor for generating informing, to indicate the user to pay attention to the photographing quality, or to select the thermal imaging data frame with the best photographing quality for the subsequent processing.

The auxiliary information may at least include an analysis value, an environmental temperature, a background factor, a wind speed, humidity, a distance, or a combination thereof, or may be other auxiliary information acquired by the thermal imaging device 100 (including the information set by the users), in the scope of the factors affecting the information related to the specified thermal imaging data frame selected by the selecting part 11B and/or the information informed by the informing part 11D.

In the infrared detection field, according to the different auxiliary information, the quality and important extent of the acquired thermal imaging data frame may be different. Thus, different conditions may be used for responding the processing for the specified thermal imaging data frame, such as comparing, selecting, or informing. For example, when there is the analysis value greater than the specified comparing value (such as a threshold of defects) in the acquired specified body thermal image, which represents that the body has defects, the attention of the users is aroused. At that moment, as the correlation degree is closer, the special information related to the thermal imaging data frame with the analysis value exceeding the standard may be preferably selected and informed, to instantly arouse the attention of the users, providing significance for the infrared detection. For example, as the affecting factor such as the environmental temperature, the background, the wind speed, and the background factor (such as the difference between the background and the body thermal image, the thermal field distribution of the background) is considered, when the correlation degree is closer, the above affecting factor may cause the different thermal imaging quality and reduce the subsequent analyzing significance, and the thermal imaging data frame with the less interference of other affecting factors may be selected and informed.

The auxiliary information acquiring part may acquire the auxiliary information according to the thermal imaging device 100 or the device connected in the thermal imaging device 100 or corresponding functional parts (not shown). For example, the analysis value (the analysis value may be the temperature value acquired via analysis, the AD value, the color value in the pseudo-color thermal image, a ratio of specified pixel values, or the value acquired after calculation of the above value according to a specified formula, and the analysis value acquired by the analysis part may direct to the whole pixels in the thermal imaging data frame or the pixels in a specified analysis area) may be acquired via an analysis part, the environmental temperature may be acquired by a temperature sensor, the humidity may be acquired by a hygrometer, and the distance between the thermal imaging device 100 and the body may be acquired by a rangefinder. The auxiliary information may be acquired according to the auxiliary information prestored in the storage medium, such as the historical data of the auxiliary information, or may be acquired according to the comparison between the currently detected auxiliary information and the historical data of the auxiliary information prestored in the storage medium. The acquirement of the auxiliary information is public to the persons having ordinary skill in the art.

Further, the comprehensive evaluating value is acquired according to the specified information and/or the auxiliary information. For example, the special information in the detected specified information corresponds to different coefficients, and the evaluating value is acquired by combining other special information in the detected specified information and the coefficient. For example, according to the weighted value of different information, the evaluating value may be acquired by weighting. The final evaluating value may be acquired via different calculation modes. For example, in FIG. 9, supposing that an infrared thermal image 901 in FIG. 9(c) is acquired according to a detecting window with the window coefficient of 0.94, and an infrared thermal image 902 is acquired according to a detecting window with the window coefficient of 0.8, evaluating value=correlation degree value×window coefficient (the detecting window may reflect an approximate position and dimension). Therefore, even if the correlation degree value of the infrared thermal image 901 is smaller than that of the infrared thermal image 902, the evaluating value is greater.

Further, the comprehensive evaluating value may be acquired according to the specified information and the auxiliary information. For example, the evaluating value may be acquired according to the position, the dimension, the inclined angle, the analysis value, and the correlation degree value of the specified body thermal image. For example, the comprehensive value may be acquired according to the following formula, comprehensive evaluating value=position×position weighted coefficient+dimension×dimension weighted coefficient+inclined angle×weighted coefficient of inclined angle+analysis value×weighted coefficient of analysis value+correlation degree value×weighted coefficient of correlation degree value. In another example, the evaluating value may be acquired according to a comparing table of the detected specified information, the acquired auxiliary information, and the comprehensive evaluating value.

Further, the evaluating value may be acquired according to part of the specified information and the auxiliary information. Then, the acquired evaluating value and the specified information and/or the auxiliary information that is not used for acquiring the evaluating value may be compared with the specified comparing value by the comparing part.

The comparing value updating part 11C is used for updating the comparing value, such as updating the comparing value according to the comparing result of the comparing part 11A. When there are several comparing values, at least one of the corresponding comparing values is updated. After updating, the comparing part 11A is used for comparing the specified information detected by the detecting part 8 and/or the auxiliary information acquired by the auxiliary information acquiring part and/or the evaluating value acquired according to the specified information and the auxiliary information with the updated comparing value. When there are several comparing values, and the comparing values are all updated, the updated comparing values are correspondingly used for comparison after updating. When parts of the comparing values are updated, after updating, the updated comparing values and the comparing values without updating are used for comparison. Preferably, according to the best specified information, the best auxiliary information, or the best evaluating value acquired according to the detected specified information and/or the auxiliary information, acquired by the comparing part, at least one of the comparing values is updated.

When the detecting part 8 is configured to detect the multiple specified information of the specified body thermal image, and the comparing part 11A compares the specified information acquired by the detecting part 8 and/or the evaluating value acquired according to the detected specified information with the specified comparing values, based on the comparing result, the selecting part 11B may select the special information related to the thermal imaging data frames, and the informing part 11D may inform one or more thereof. Preferably, based on the comparing result of the comparing part, the selecting part selects to remain the special information related to the thermal imaging data frame with the correlation degree value and/or the specified information and/or the auxiliary information and/or the evaluating value (such as the evaluating value acquired according to the specified information and/or the auxiliary information) that is better than the specified comparing value. The informing part may inform the special information related to the thermal imaging data frame with the correlation degree value and/or the specified information and/or the auxiliary information and/or the evaluating value (the evaluating value acquired according to the specified information and/or the auxiliary information) that is the best or better than the specified comparing value, based on the special information related to the specified thermal imaging data frame selected and remained by the selecting part.

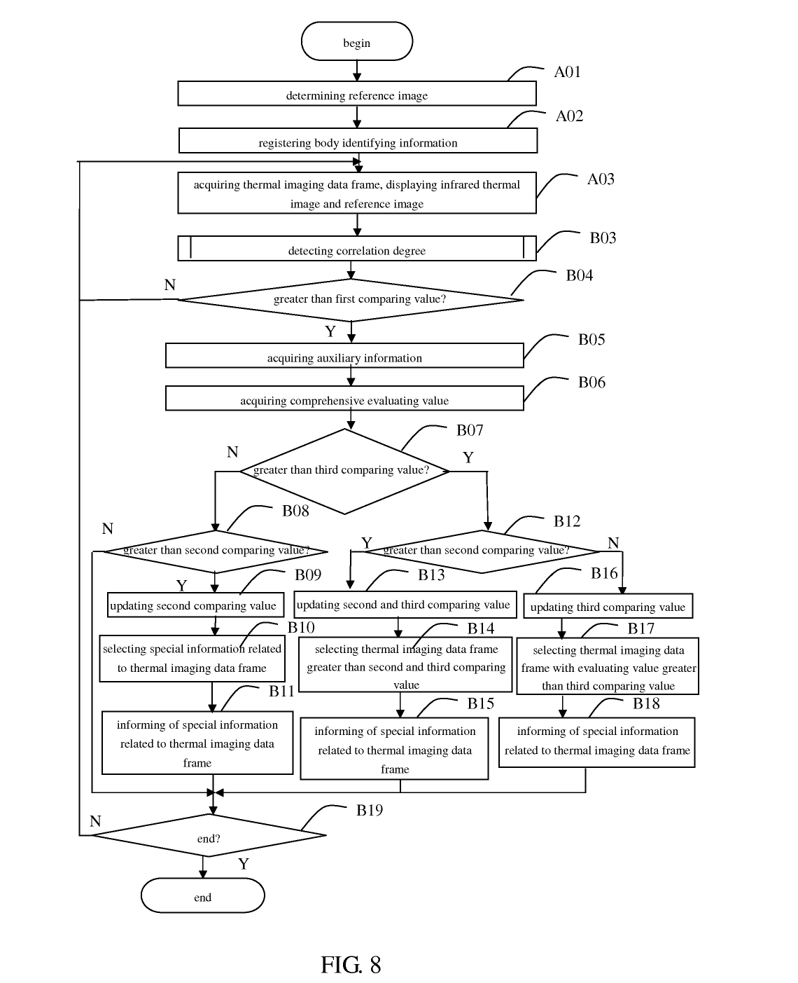

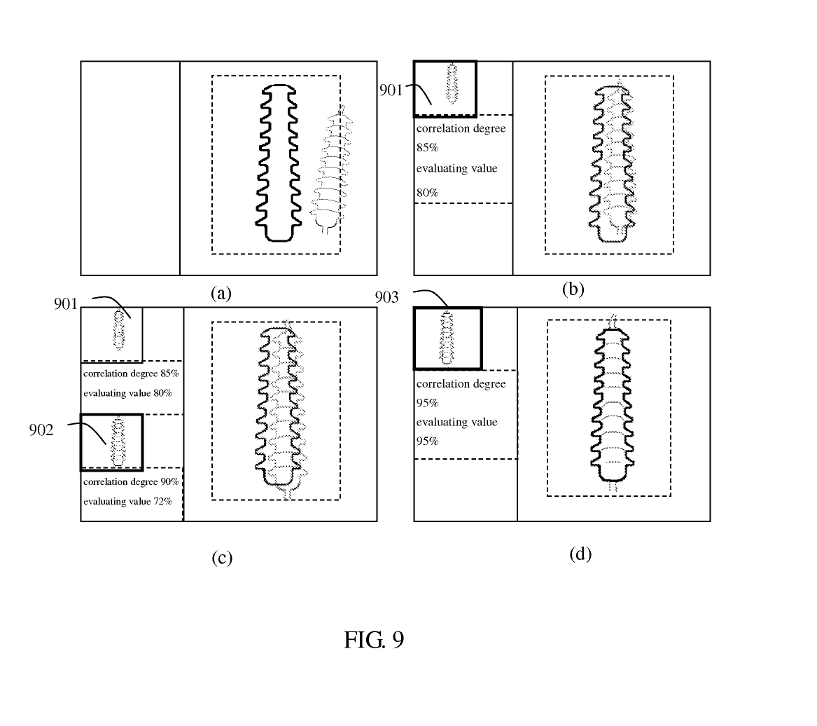

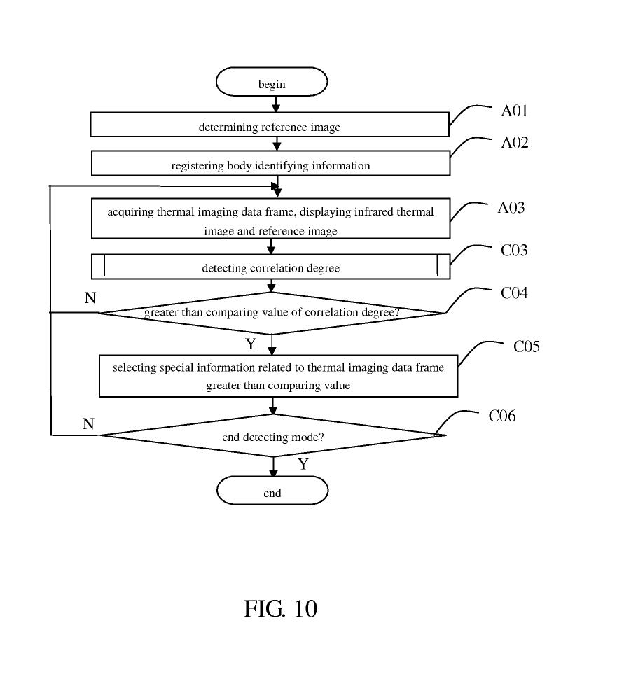

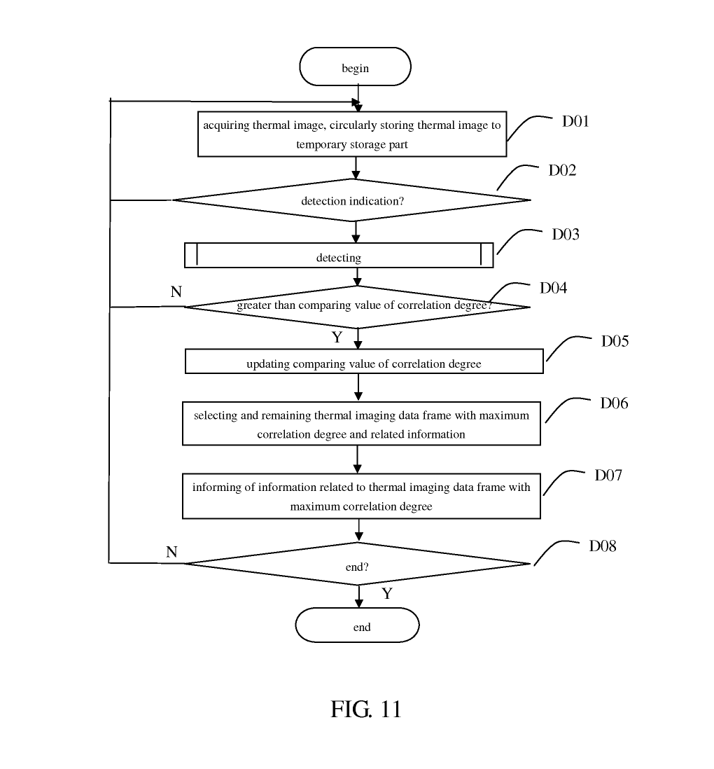

Referring to FIG. 8, the control flows of the detecting mode of the thermal imaging device 100 in the second embodiment are described. In the following description, three comparing values are taken for example. The specified information (the correlation degree value) related to the specified body thermal image in the thermal imaging data frame detected by the detecting part 8 and the evaluating value acquired according to the auxiliary information (analysis value) acquired by the auxiliary information acquiring part and the detected specified information are compared with a first comparing value, a second comparing value, and a third comparing value.

The first comparing value is prepared in advance (in the embodiment, the first comparing value of the correlation degree), is the comparing value for determining if there is a specified body thermal image (the judging value representing whether the specified body thermal image matches the body identifying information), and is not updated.

The second comparing value (in the embodiment, the second comparing value of the correlation degree) is the comparing value of the correlation degree greater than the first comparing value, and is acquired according to the detected correlation degree value of the thermal imaging data frame. When the thermal imaging data frame with the greater correlation degree value is subsequently detected, the second comparing value is updated to be the greater value.

The corresponding (such as prepared in advance) third comparing value is compared with a comprehensive evaluating value acquired according to a position, a dimension, an inclined angle, a correlation degree value, and an analysis value. When the subsequent thermal imaging data frame with the greater (better) comprehensive evaluating value is detected, the third comparing value is updated to be the greater value.

Finally, the selecting part 11B selects the special information related to the thermal imaging data frame better than the second comparing value and/or the third comparing value, facilitating the subsequent processing such as informing, analysis, diagnosis, or record.

Step A01 to step A03 are similar to the steps A01 to A03 in the first embodiment, and the description is omitted.

Step B03 is similar to the steps A04 to A08 in the first embodiment, the correlation degree is acquired via detection, and the description is omitted.

In step B04, if the detected correlation degree value of the thermal imaging data frame is greater than the first comparing value is determined. If no, it represents that the specified body thermal image is not detected, return to the step A03 and repeat the following processing, or jump to step B19 and return to the step A03 if not exited. When it is detected that the correlation degree is greater than the first comparing value in the step B04, enter into step B05.

In step B05, the auxiliary information acquiring part acquires the auxiliary information, such as the analysis value related to the specified body thermal image, for the thermal imaging data frame with the correlation degree greater than the first comparing value and/or the thermal imaging data in the detecting window of the thermal imaging data frame, such as acquiring the analysis value by controlling the analysis part to analyze. In addition, when the detecting part 8 is configured to calculate the correlation degree by detecting the pixel ratio, the position parameter of the detected specified body thermal image is not limited to be determined according to the position parameter of the detecting window. At that moment, according to the contour of the specified body extracted from the detected detecting window, the specified information related to the specified body thermal image, such as the more accurate position, dimension, and inclined angle, may be acquired.

In step B06, the evaluating value is acquired, and the comprehensive evaluating value acquired according to a position, a dimension, an inclined angle, a correlation degree value, and an analysis value of the specified body thermal image is acquired. For example, the comprehensive evaluating value may be acquired according to the following formula, comprehensive evaluating value=position×weighted coefficient of position+dimension×weighted coefficient of dimension+inclined angle×weighted coefficient of inclined angle+correlation degree value×weighted coefficient of correlation degree+analysis value×weighted coefficient of analysis value. Otherwise, in another mode, the evaluating value may be acquired according to a comparing table of the detected specified information and the acquired auxiliary information and the comprehensive evaluating value.

In step B07, the comparison with the third comparing value is performed. If the third comparing value is greater, in step B08, the detected correlation degree value is compared with the second comparing value. If no, jump to step B19, representing that the thermal imaging data frame with the correlation degree greater than that of the currently detected thermal imaging data frame is detected previously. If yes, in steps B09 to B10, the comparing value updating part 11C updates the second comparing value according to the detected maximum correlation degree value. Further, the selecting part 11B remains the special information related to the thermal imaging data frame at the specified area of the temporary storage part 2 or allows the previous special information to be replaced (the replacement is performed when there is the special information related to the previous thermal imaging data frame with the correlation degree smaller than that of the currently detected thermal imaging data frame and the evaluating value is not the greatest in the remained thermal imaging data frame), and in step B11, the special information related to the thermal imaging data frame with the correlation degree greater than the second comparing value is informed.

In the step B07, if the comprehensive evaluating value is greater than the third comparing value, in step B12, the correlation degree value is compared with the second comparing value.

If the correlation degree value is greater than the second comparing value, in steps B13 to B14, the comparing value updating part 11C updates the second comparing value and the third comparing value according to the detected maximum correlation degree value of the thermal imaging data frame and the maximum comprehensive evaluating value. Further, the selecting part 11B remains the special information related to the thermal imaging data frame at the specified area of the temporary storage part 2 or allows the previous special information to be replaced (if there is the previous special information). In step B11, the special information related to the thermal imaging data frame with the correlation degree greater than the second comparing value and with the comprehensive evaluating value greater than the third comparing value is informed.

If the second comparing value is greater, in steps B16 to B17, the comparing value updating part 11C updates the third comparing value according to the detected comprehensive evaluating value of the thermal imaging data frame. Further, the selecting part 11B remains the special information related to the thermal imaging data frame with the detected maximum comprehensive evaluating value at the specified area of the temporary storage part 2, and the previous special information is replaced (if there is the special information related to the previous thermal imaging data frame, the evaluating value of the previous thermal imaging data frame is smaller than that of the currently detected thermal imaging data frame, and the correlation degree is not the best in the remained thermal imaging data frames, the replacement is performed). Further, in step B18, the special information related to the thermal imaging data frame with the comprehensive evaluating value greater than the third comparing value is informed.

In step B19, whether the detecting mode is exited is determined. If yes, end. If no, return to the step A03. The informing information, infrared thermal image, and the reference image acquired by the selected special information may be displayed, and the subsequent processing may be repeated. Thus, for the continuously photographed thermal imaging data frames, according to the detected specified information, the special information related to the thermal imaging data frame better than the second comparing value and/or the third comparing value is selected and informed, thereby facilitating the subsequent processing such as informing, analysis, diagnosis, and record. The further detecting condition of the specified information is whether the correlation degree of the detected thermal imaging data frame is greater than the first comparing value, thereby avoiding photographing the incorrect parts and capable of indicating the effective special information. According to the different comparing values, the better may include that to be smaller or greater than the comparing value.

Referring to FIG. 9, the changes of the display interfaces during photographing are described.

In FIG. 9(a), when the thermal imaging data with the correlation degree greater than the first comparing value (supposing that the percentage converted by the first comparing value is 72%), the dynamic infrared thermal image and the reference image are displayed.

Then, in FIG. 9(b), when the thermal imaging data frame with the correlation degree greater than the first comparing value is detected at the first time, the dynamic infrared thermal image, the reference image, and the informing information related to the detected thermal imaging data frame may be displayed. The informing information is generated according to the remained special information of the thermal imaging data frame indicated by the selecting part 11B, such as the thermal imaging data frame, the correlation degree value, and the evaluating value. The informing information includes the reduced infrared thermal image 901 generated by the thermal imaging data frame, the correlation degree percentage 85% converted from the correlation degree value, and the evaluating value percentage 80% converted from the evaluating value. Further, the comparing value updating part 11C may update the second comparing value to be 85% and updates the third comparing value to be 80%. When the thermal imaging data frame greater than the second comparing value and/or the third comparing value is not detected subsequently, the display part 10 remains a state of displaying the informing information, such as the infrared thermal image 901, and the dynamic infrared thermal image. Since the infrared thermal image 901 is the informing information generated by the currently acquired new special information, a thickened box is provided for reminding the users.

Then, in FIG. 9(c), when the thermal imaging data frame greater than the second comparing value is detected, the dynamic infrared thermal image, the reference image, and the special information related to the detected thermal imaging data frame are displayed. The special information includes the reduced infrared thermal image 902 generated by the thermal imaging data frame. Thereby, since the correlation degree to which the infrared thermal image 902 corresponds is greater than that to which the infrared thermal image 901 corresponds, and the evaluating value to which the infrared thermal image 902 corresponds is smaller than that to which the infrared thermal image 901 corresponds, the selecting part 11B remains the special information related to the two thermal imaging data frames, the comparing value updating part 11C updates the second comparing value according to the correlation degree to which the infrared thermal image 902 corresponds, and the informing part 11D allows the display part 10 to display the informing information generated according to the special information acquired by the two different thermal imaging data frames. Further, the thickened box of the infrared thermal image 901 is removed, and the box of the infrared thermal image 902 is thickened. At that moment, since the special information such as the thermal imaging data frames corresponding to the infrared thermal images 901, 902 is remained at the temporary storage part 2, the users may select the thermal imaging data frame for subsequent record or analysis from the displayed information such as the infrared thermal images 901, 902 on the display part 10.

Further, in FIG. 9(d), when the thermal imaging data frame with the detected correlation degree greater than the second comparing value and with the evaluating value greater than the third comparing value is detected, the selecting part 11B remains the special information related to the infrared thermal image 903 or deletes the special information related to the infrared thermal images 901, 902, the comparing value updating part 11C updates the second comparing value and the third comparing value according to the correlation degree (95%) and the evaluating value (95%) to which the infrared thermal image 903 corresponds, and the informing part 11D allows the display part 10 to display the dynamic infrared thermal image, the reference image, and the special information related to the detected thermal imaging data frame. The special information includes the reduced infrared thermal image 903 generated by the thermal imaging data frame.

Thus, based on the comparing result of the comparing part, the selecting part selects and remains the special information related to the thermal imaging data frame with the correlation degree value and/or the evaluating value better (such as greater) than the specified comparing value (the second comparing value, the third comparing value). Further, if the informing is performed, based on the control of the informing part 11D, the information acquired by the thermal imaging data frame with the maximum correlation degree and/or the maximum evaluating value is capable of being displayed on the interface of the display part 10, facilitating the photographing of the users, and the casual photographing may easily acquire the thermal imaging data frame with the better quality.

According to the above, in the embodiment, the effects of the first embodiment can be achieved. Further, the specified information of the detected specified body thermal image and the auxiliary information acquired by the auxiliary information acquiring part is as the selecting and informing factor, thereby reducing the operation difficulty of visual aiming, improving the detecting accuracy of the body during detection, avoiding incorrect operation, and indicating the specified state. The common users can easily grasp the photographing skill Any product where the embodiment of the invention is applied may not be necessary to achieve all of the advantages at the same time.

In addition, although three comparing values are taken for example, there may be more comparing values, corresponding to several different important evaluating values and/or the auxiliary information and/or the detected specified information, such as the evaluating value acquired according to the position, dimension, and inclined angle of the specified body thermal image, or the evaluating value acquired according to the analysis value and the environmental temperature.

In addition, in the second embodiment, the several comparing values (three or two) are taken for example, parts of the comparing values may be updated, and others may not be updated. However, all of the comparing values may be updated, or the comparing value updating part 11C may be removed as the multiple corresponding comparing values are prepared in advance and are free of updating.

In the second embodiment, the correlation degree value and the evaluating value acquired according to the specified information and the auxiliary information are taken for example, and the informing may be performed according to the maximum correlation degree and/or the maximum evaluating value. One of them may be only informed. Otherwise, the more comparing items are configured, the special information of the better thermal imaging data frame selected according to different comparing items may be informed, or the correlation degree value and the evaluating values may be informed according to a sequence or a prior grade.

The informing part 11D performs informing according to the special information related to the specified thermal imaging data frame selected by the selecting part 11B and/or the updating information of the comparing value updating part 11C (such as an updating action or the information of the updated comparing value), and may preferably inform the special information related to the specified thermal imaging data frame currently selected by the selecting part (usually the correlation degree value and/or the evaluating value greater than the comparing value), thus to facilitate the users. For example, the position, dimension, inclined angle, correlation degree value of the specified body may be as the evaluating factor, thereby acquiring the thermal imaging data frame with the better quality or the thermal imaging data frame satisfying the specified photographing requirement, and the auxiliary information may be as the evaluating factor, thereby optimizing to inform the thermal imaging data frame.

Further, in the second embodiment, when the thermal imaging data frame greater than the previous correlation degree and/or the evaluating value is detected, the selecting part 11B allows the special information acquired by the previous thermal imaging data frame to be replaced (such as delete) or to be continually remained. At that moment, the informing part 11D may display the special information related to the multiple thermal imaging data frames, such as displaying the special information according to a sequence of the correlation degree and/or the evaluating value.

### Embodiment Three

The difference among the third embodiment, the first embodiment, and the second embodiment is that in the third embodiment, the functional part (not shown) of the comparing value updating part 11C in the thermal imaging device 100 in FIG. 1 is removed, and when the detected thermal imaging data frame is greater than the specified comparing value of the correlation degree, the selection is performed, and the comparing value of the correlation degree is not updated.

Step A01 to step A03 are similar to the steps A01 to A03 in the first embodiment, and the description is omitted.

Step C03 is similar to the steps A04 to A08 in the first embodiment, and the description is omitted.

In step C04, the acquired correlation degree value of the thermal imaging data frame is compared with the specified comparing value (such as the judging value for determining if the specified body thermal image matches the body identifying information). If no, return to the step A03, or jump to step C06 and return to the step A03 if not exited.

If yes, in step C05, the information related to the thermal imaging data frame greater than the specified comparing value is selected, or the subsequent processing such as informing, analysis, and record is performed. For example, the image acquired according to the thermal imaging data frame may be displayed with the dynamic infrared thermal image and the reference image. In addition, the display of the dynamic infrared thermal image is switched to the display of the frozen image of the thermal imaging data frame. Otherwise, after the display of the dynamic infrared thermal image is switched to the display of the frozen image of the thermal imaging data frame, in response to the indication of the user, the display of the dynamic infrared thermal image is switched back, or the display of the image acquired according to the thermal imaging data frame, the dynamic infrared thermal image, and the reference image is switched.

In step C06, if the detection is exited is determined. If no, return to the step A03 and repeat the subsequent processing. If yes, exit.

Further, when the specified body thermal image is detected in the subsequent thermal imaging data frame, the previously remained thermal imaging data frame is replaced, and the related information is displayed and informed, or the display of the related information is performed at the same time. For example, when the specified amount of the thermal imaging data frames is remained, the users is informed of selecting the thermal imaging data frame for subsequent processing, such as record or analysis, from the thermal imaging data frames.

According to the above, in the third embodiment, when the thermal imaging data frame with the correlation degree greater than the specified comparing value is detected, the special information related to the thermal imaging data frame is selected, or the users is informed, thereby reducing the operation strength of visual aiming. The common users can easily grasp the photographing skill, and the operation is simple. Since the comparing value is not updated, in the subsequent photographing, the quality of the acquired thermal imaging data frame may be worse than before.

The deformation of the embodiment may be that the specified information related to the specified body thermal image during detection of the thermal imaging data frame, the specified information related to the specified body thermal image during detection of the thermal imaging data frame and the acquired auxiliary information, the evaluating value acquired according to the specified information acquired by the detecting part and/or the auxiliary information acquired by the auxiliary information acquiring part, or a combination thereof, is compared with the specified comparing value, to acquire a comparing result, further to determine the selection of the special information related to the specified thermal imaging data frame.

In addition, the selecting part 11B may be removed. That is, when the specified body thermal image is detected, the informing is performed, such as vibration to remind the users.

### Embodiment Four

The difference among the fourth embodiment, the first embodiment, the second embodiment, and the third embodiment is that when the thermal imaging device 100 determines that there is the detecting indication, based on the thermal imaging data frames stored in the temporary storage part 2, the thermal imaging device 100 detects and selects the best (such as with the maximum correlation degree) thermal imaging data frame, which is suitable for photographing a fast moving body.

Referring to FIG. 11, the control flows of the detecting mode of the thermal imaging device 100 in the third embodiment are described.

In step D01, the acquired thermal imaging data frame, such as the thermal imaging data photographed by the photographing part 1, is transferred to the temporary storage part 2. The display part 10 displays the dynamic infrared thermal image and the reference image. The temporary storage part 2 may be a circular storage capable of temporarily storing multiple (such as 50 frames) thermal imaging data frames, such as circularly storing the thermal imaging data frames photographed by the photographing part 1.

In step D02, the control part 11 determines if there is the detection indication. For example, when the detecting indication of the users via the operation part 12 is detected, the next step is performed. The detecting indication may not be emitted by the operation of the users, or may be emitted in a specified timing mode.

In step D03, the thermal imaging data frame is read from the temporary storage part 2 and is detected, and the calculated correlation degree acquired by the read thermal imaging data frame and the thermal imaging data frame is correspondingly stored to the temporary storage part 2. After the specified amount (or all of the thermal imaging data frames) of the thermal imaging data frames is detected, the maximum correlation degree value and the corresponding thermal imaging data frame are acquired.

In step D04, the acquired maximum correlation degree is compared with the specified comparing value. If no, return to the step D01, the infrared thermal image is displayed continually or the words that the thermal imaging data frame greater than the comparing value is not detected are displayed, or jump to the step D08 and return to the step D01 if not exited.

If yes, in step D05, according the detected maximum correlation degree value, the comparing value is updated, in step D06, the special information related to the thermal imaging data frame with the maximum correlation degree is selected and remained, and in step D07, informing is performed, such as displaying the infrared thermal image acquired according to the thermal imaging data frame and the dynamic infrared thermal image. The updated comparing value may be used for the next detection, thereby ensuring to select the special information related to the thermal imaging data frame with the better quality.

In step D08, if the detection is exited is determined. If no, return to the step D01, and repeat the subsequent processing. If yes, exit.

According to the above, in the fourth embodiment, when the detecting indication is received, the thermal imaging data frame with the maximum correlation degree is detected from the thermal imaging data frames stored in the temporary storage part 2, thereby reducing the operation strength of visual aiming, simplifying the operation, reducing the calculating speed load of the processor, reducing the cost of the thermal imaging device 100, and being suitable for photographing the fast moving object. The common users can easily grasp the photographing skill.

### Other Embodiments

In the above embodiments, the schematic thermal imaging device 100 is described respectively, capable of being suitable for different kinds of portable or on-line thermal imaging devices. This invention is not only applicable to the thermal imaging device with the photographing function, but is also applicable to the thermal image processing devices such as a thermal image processing device (such as a computer, a personal digital assistant, or a display device used in a set of a thermal imaging device with the photographing function) continuously receiving thermal images from outside and processing thermal images (such as acquiring the thermal imaging data frame according to the time sequence). The thermal image processing device may be a computer, which is wirelessly or wiredly connected with the thermal imaging device via a communication interface (one example of the acquiring part may be that the thermal image processing device is connected with an external device according to communication specification such as USB, 1394, or network), and continuously receives the thermal imaging data frame output by the connected thermal imaging device. The detection, comparison, and selection are similar to that in the above embodiment, which is without description.

This invention is not limited to acquire the thermal imaging data frame by photographing or from outside, which may also be as one part or functional module in the thermal imaging device or the thermal image processing device, such as acquiring the thermal imaging data frame from other parts.

In addition, preferably there is the informing part. However, the informing part may be removed. For example, the selected special information may be examined by operation of the users.

In addition, the detection may be set in the specified detecting time or for the specified amount of the frames, to inform the best (such as the maximum correlation degree) frame. The informing of the best frame is not limited, and the multiple frames may be informed.

Further, the whole area of the body may be detected, and the multiple detecting windows composed by the multiple parts by dividing the body may be detected, thereby capable of achieving more accurate detection. During the detection for each part, the corresponding body identifying information (may be templates or characteristics) may be prepared. The corresponding characteristics in the detecting window may be calculated according to the characteristics of the template, and the judging result is acquired according to the comparing value corresponding to the characteristics. For example, the final judging value may be acquired according to the weighting of the characteristics. According to the characteristics, the comparing result of one characteristic and the infrared thermal image is calculated, and when comparing result is greater than the specified threshold, the comparing result of the next characteristic and the infrared thermal image is calculated, and the final judging result is acquired according the multiple comparison.

In the embodiment, the detecting area may be displayed as the reference image or part. When the reference image reflects the morphological character, the detecting area may be set (such as the detecting area acquired by enlarging the bounding rectangle of the reference image for a specified ratio) according to the position parameter of the reference image located in the infrared thermal image, thereby accelerating the detecting speed and ensuring the photographing quality.

In the above embodiment, the processing such as the detection, selection, informing of the thermal imaging data frame, the number of the comparing value, the updating of the comparing value, and the acquirement of the auxiliary information, may be combined in different ways, which are all in the scope of the invention.

Further, whether the specified body thermal image is detected is not limited to according to the comparison of the correlation degree value and the comparing value of the correlation degree. Otherwise, the detected specified information, the auxiliary information, the evaluating value acquired according to the specified information, the evaluating value acquired according to the auxiliary information, the evaluating value acquired according to the specified information and the auxiliary information, or a combination thereof may be compared with the specified comparing value, to determine if the specified body thermal image is detected.

In the above embodiment, the comparing value updating part may update at least one comparing value according to the best specified information acquired by the comparing part, the best auxiliary information, or the best evaluating value acquired according to the acquired specified information and/or the auxiliary information. Based on the comparing result of the comparing part, the selecting part may select the special information related to the thermal imaging data frame with the specified information and/or the auxiliary information and/or the evaluating value better than the specified comparing value, or remain. The selecting condition may be that the acquired specified information and/or the auxiliary information and/or the evaluating value is better than the specified comparing value. The informing part may inform the special information related to the thermal imaging data frame with the correlation degree value and/or the specified information and/or the auxiliary information and/or the evaluating value that is the best or better than the specified comparing value, based on the special information related to the specified thermal imaging data frame selected and remained by the selecting part. The better may include the following conditions, such as smaller than the comparing value, greater than the comparing value, in the range of the comparing value, exceeding the range of the comparing value, or closer to the comparing value. When there is multiple comparing values, one or all of them may be greater than the comparing value, smaller than the comparing value, located in the range of the comparing value, exceeding the range of the comparing value, or closer to the comparing value. The best may be that the detected specified information and/or the auxiliary information and/or the evaluating value is the greatest, the smallest, closest to the comparing value, or certain value in the range of the comparing value.

The selected thermal imaging data frame may be used for subsequent processing such as display, analysis, diagnosis, transmission, and record. The analysis may be to acquire the analysis value such as the temperature value, the ratio value of specified pixel values, or the value acquired by calculation of the above values according to the specified formula. The diagnosis may be to acquire the diagnosis result, such as the diagnosis conclusion (such as defect information or normal information), or a triggering signal, by comparing the analysis value and the specified threshold. The processing meanings are public to the persons having ordinary skill in the art.

In addition, there may be different kinds of deformed embodiments. For example, a thermal image storing part may be used for storing the continuously acquired thermal imaging data frames, and the thermal image storing part, such as the temporary storage part 2, may be a circular storage capable of temporarily storing the thermal imaging data frames (such as 50 frames) for circularly storing the thermal imaging data frames continuously acquired by the acquiring part (such as the photographing part 1). Thereby, in the fourth embodiment, in response to the specified indication, the detection is performed. In addition, in other deformed embodiments, the detecting part is used for detecting the specified information related to the specified body thermal image in the thermal imaging data frame based on the continuously acquired thermal imaging data frames; the thermal image storing part is used for correspondingly storing the thermal imaging data frame and the acquired specified information; based on the specified indication, the comparing part is used for comparing the specified information acquired by the detecting part and/or the evaluating value acquired by the specified information with the specified comparing value based on the thermal imaging data frames and the related specified information stored in the thermal image storing part; the selecting part is used for selecting the special information related to the specified thermal imaging data frame based on the comparing result of the comparing part. Thus, when the specified indication such as the indication of the users or the specified timing is achieved, the comparing part may perform the comparison. Otherwise, the multiple detection processing may be performed. For example, the detecting part detects to acquire (such as approximate) the first specified information, the thermal image storing part is used for correspondingly storing the thermal imaging data frame and the acquired first specified information by detection, then based on the specified indication, the detecting part performs the detection again to acquire the second specified information, and the comparing part compares the detecting result and the specified comparing value. Otherwise, there may be multiple detection and/or comparison processing. For example, the thermal image storing part may store the previously compared and selected thermal imaging data frame and the corresponding specified information, for the subsequent (such as in response to the specified indication) detection and comparison.

The above embodiments are described according to a step sequence. However, there are different sequences in different embodiments, which is not limited to the above embodiments. When the control part 11 and the image processing part include multiple processors, some steps may be processed in parallel.

The storage medium storing the body identifying information may be a storage medium in the thermal imaging device 100, such as a non-volatile storage medium, i.e. the flash memory 3 or the storage card 6, or a volatile storage medium i.e. the temporary storage part 2, or may be other storage mediums wiredly or wirelessly connected with the thermal imaging device 100, such as other wiredly or wirelessly connected devices via the communication I/F 4, i.e. other storage devices, a storage medium in a thermal imaging device, a computer, or a network destination.

In one preferred embodiment, the body identifying information is related to the body information, and the different applicable body information may be prepared according to different applications. For example, in the electric power industry, the body information may be recognized information representing the identity of the body, such as the information representing the position, type, and phase of the body, or may be the information representing the type of the body. Obviously, the body identifying information is not limited to be related to the body information.

In the invention, a computer (or a device such as a CPU, MPU) with the above functional system or device may be performed by the single program or the program record on the storage device, and the computer may read and run the program record on the storage device to achieve the above functions. Thereby, the program may be provided to the computer or the thermal imaging device via network or different types of record mediums (such as a computer readable medium) as the storage device.

This invention provides a computer program, and the digital signals composing the computer program are record on a readable record medium in a computer or a thermal imaging device, such as a hard disk, a memorizer. The following steps are performed after the program is executed.

An acquiring step is used for continuously acquiring the thermal imaging data frame.

A display controlling step is used for controlling to display the dynamic infrared thermal image acquired according to the acquired thermal imaging data frame and the reference image.

A detecting step is used for detecting the specified information related to the specified body thermal image based on the acquired thermal imaging data frame.

A comparing step is used for comparing the specified information acquired in the detecting step and/or the evaluating value acquired according to the specified information acquired by detection with the specified comparing value.

A selecting step is used for selecting the special information related to the specified thermal imaging data frame based on a comparing result in the comparing step.

This invention further provides a readable storage medium storing a computer program for exchanging digital data. The computer program allows the computer in the thermal imaging device to perform the following steps.

An acquiring step is used for continuously acquiring the thermal imaging data frame.

A display controlling step is used for controlling to display the dynamic infrared thermal image acquired according to the acquired thermal imaging data frame and the reference image.

A detecting step is used for detecting the specified information related to the specified body thermal image based on the acquired thermal imaging data frame.

A comparing step is used for comparing the specified information acquired in the detecting step and/or the evaluating value acquired according to the specified information acquired by detection with the specified comparing value.

A selecting step is used for selecting the special information related to the specified thermal imaging data frame based on a comparing result in the comparing step.

Although the function block in the figures may be realized via hardware, software, or a combination thereof, the function block may be not necessary to be realized in one-by-one mode. One software or hardware module may be used for realizing multiple function blocks, or multiple software or hardware units may be used for realizing one function block. In addition, the processing and control functions of parts or whole in the embodiments may be realized via a special-use circuit, a general processor, or a programmable FPGA.

In addition, the body application in the electric power industry as the scene is taken for example, and different fields of the infrared detection are also applied.

The above description is just detailed examples (embodiments) of the invention, and different examples and description do not limit the substantive contents of the invention. Further, different embodiments may be taken place and combined to form more embodiments. Persons having ordinary skill in the art may make various modifications and changes without departing from the scope and spirit of the invention.

1-50. (canceled)

51. An infrared selecting device, comprising:
an acquiring part for continuously acquiring a thermal imaging data frame;
a display controlling part for controlling to display a reference image and a dynamic infrared thermal image acquired according to the acquired thermal imaging data frame;
a detecting part for detecting specified information related to a specified body thermal image based on the acquired thermal imaging data frame;
a comparing part for comparing the specified information acquired by the detecting part, an evaluating value acquired according to the specified information acquired by detection, or a combination thereof, with a specified comparing value;
a selecting part for selecting special information related to the specified thermal imaging data frame based on a comparing result of the comparing part.

52. The infrared selecting device according to claim 51, wherein the specified information at least comprises a position, a dimension, an inclined angle, a correlation degree value of the specified body thermal image acquired via detection, or a combination thereof.

53. The infrared selecting device according to claim 52, wherein the comparing part is used for comparing the specified information acquired by the detecting part, the evaluating value acquired according to the specified information acquired via detection, a combination thereof, the auxiliary information acquired by an auxiliary information acquiring part, the evaluating value acquired according to the specified information and the auxiliary information, the evaluating value acquired according to the auxiliary information, or a combination thereof, with the specified comparing value.

54. The infrared selecting device according to claim 53, wherein the specified information at least comprises a position, a dimension, an inclined angle, a correlation degree value of the specified body thermal image acquired via detection, or a combination thereof, and the auxiliary information at least comprises an analysis value, an environmental temperature, a wind speed, a background factor, humidity, a distance, or a combination thereof.

55. The infrared selecting device according to claim 51, wherein the special information is the thermal imaging data frame selected from the continuously acquired thermal imaging data frames, the thermal imaging data frame selected from the thermal imaging data frame after specified processing for the continuously acquired thermal imaging data frames, data acquired after specified processing for the thermal imaging data frame selected from the continuously acquired thermal imaging data frames, the specified information acquired by detection, the auxiliary information acquired by the auxiliary information acquiring part, the evaluating value acquired according to the specified information, the evaluating value acquired according to the auxiliary information, the evaluating value acquired according to the specified information and the auxiliary information, the indicating information generated according to the specified information, the indicating information generated according to the auxiliary information, the indicating information generated according to one or more of the above evaluating values, or a combination thereof.

56. The infrared selecting device according to claim 51, wherein when a specified selecting condition is satisfied, the selecting part selects the special information related to the specified thermal imaging data frame, and the selecting condition comprises that at least one of the specified information, the auxiliary information, and the evaluating value acquired according to the specified information and/or the auxiliary information satisfies at least one of the followings: to be better than the specified comparing value, to be greater than the specified comparing value, to be smaller than the specified comparing value, to be located in a range of the comparing value, to exceed the range of the comparing value, or to be closer to the comparing value.

57. The infrared selecting device according to claim 51, wherein the special information related to the specified thermal imaging data frame at least comprises the specified thermal imaging data frame or the data acquired after specified processing for the specified thermal imaging data frame, and the specified thermal imaging data frame at least comprises the best thermal imaging data frame detected from the acquired thermal imaging data frames, the thermal imaging data frame with the best correlation degree, the thermal imaging data frame with the best detected evaluating value, the thermal imaging data frame with a position, a dimension, and a rotating angle that is closest to that of the reference image, the thermal imaging data frame where the specified body thermal image is detected, or a combination thereof.

58. The infrared selecting device according to claim 51, wherein the selecting part performs remaining control for the selected special information.

59. The infrared selecting device according to claim 51, wherein the selecting part performs remaining control for the selected special information, the selecting part replaces at least one of the remained special information via the special information subsequently selected by the selecting part according to a specified condition, and the specified condition comprises that based on the detected best thermal imaging data frame, the thermal imaging data frame with the maximum correlation degree, the detected thermal imaging data frame with the best evaluating value, the thermal imaging data frame where the specified body thermal image is detected, indication of users, the specified time of remaining, the exceeding of the remained specified amount, a change of the selected body information, a change of the body identifying information related to detection, or a combination thereof.

60. The infrared selecting device according to claim 51, further comprising:
a comparing value updating part for updating the comparing value,
after the comparing value is updated, the comparing part being used for comparing the specified information acquired by the subsequent detection of the detecting part, the evaluating value acquired according to the specified information, or a combination thereof, with the updated comparing value.

61. The infrared selecting device according to claim 53, further comprising:
a comparing value updating part for updating the comparing value,
after the comparing value is updated, the comparing part being used for comparing the specified information acquired by the subsequent detection of the detecting part, the auxiliary information acquired by the auxiliary information acquiring part, the evaluating value acquired according to the specified information, the evaluating value acquired according to the auxiliary information, the evaluating value acquired according to the specified information and the auxiliary information, or a combination thereof, with the updated corresponding comparing value.

62. The infrared selecting device according to claim 51, further comprising:
a comparing value updating part for updating the corresponding comparing value according to the best specified information, the best auxiliary information, the best evaluating value acquire according to the detected specified information and/or the auxiliary information, acquired by the comparing part, or a combination thereof.

63. The infrared selecting device according to claim 51, further comprising an informing part for informing of the special information selected by the selecting part, updating information of the comparing value, an updating event of the comparing value, the latest special information selected by the selecting part, the special information related to the best thermal imaging data frame selected by the selecting part, the special information related to the thermal imaging data frame better than the specified comparing value selected by the selecting part, or a combination thereof.

64. The infrared selecting device according to claim 51, wherein the informing part allows to display informing information reflecting the selected special information, and the informing information at least comprises a reduced infrared thermal image acquired according to one selected thermal imaging data frame, the correlation degree value corresponding to one selected thermal imaging data frame, the evaluating value corresponding to one selected thermal imaging data frame, the special information related to the thermal imaging data frame that is best or better than the specified comparing value, or a combination thereof.

65. The infrared selecting device according to claim 51, further comprising a specified processing part for performing specified processing for the special information selected by the selecting part, and the specified processing at least comprises record, transmission, analysis, diagnosis, display, or a combination thereof.

66. The infrared selecting device according to claim 65, further comprising a second selecting part for selecting the thermal imaging data frame remained by the selecting part, the specified processing part for performing specified processing for the selected thermal imaging data frame.

67. The infrared selecting device according to claim 51, wherein the reference image is located in the infrared thermal image and with a specified position parameter, the detecting part performs the detection according to a specified detecting area in the thermal imaging data frame, and the detecting area is set according to the position parameter of the reference image located in the infrared thermal image.

68. The infrared selecting device according to claim 51, wherein the reference image reflects morphological characters of a body.

69. The infrared selecting device according to claim 51, further comprising:
a body information selecting part for selecting body information according to the body information stored in a storage medium, the storage medium being used for storing the body information and the body identifying information related to the body information;
the detecting part for performing the detection according to the body identifying information related to the detection, which is configured according to the body identifying information related to the selected body information.

70. The infrared selecting device according to claim 51, further comprising:
a body information selecting part for selecting the body information according to the body information stored in a storage medium, the storage medium being used for storing the body information and the constituted data of the reference image related to the body information or the body information and the constituted data of the reference and body identifying information related to the body information;
the reference image displayed with the infrared thermal image together being the reference image acquired according to the constituted data of the reference image related to the selected body information;
the detecting part for performing detection according to the body identifying information related to the detection, which is configured according to the constituted data of the reference image related to the selected body information, the body identifying information related to the selected body information, or a combination thereof.

71. The infrared selecting device according to claim 51, wherein the infrared selecting device is a portable thermal imaging device or an on-line thermal imaging device, and the acquiring part is a photographing part for acquiring the thermal imaging data frame via photographing.

72. The infrared selecting device according to claim 51, wherein the detecting part is used for detecting the specified information related to the specified body thermal image according to the thermal imaging data frames stored in a thermal image storing part, the thermal image storing part is used for storing the thermal imaging data frames acquired by the acquiring part, the comparing part is used for comparing the specified information acquired by the detecting part and/or the evaluating value acquired according to the specified information acquired via detection with the specified comparing value, and the selecting part is used for selecting the special information related to the specified thermal imaging data frame based on a comparing result of the comparing part.

73. An infrared selecting method, comprising:
an acquiring step for continuously acquiring a thermal imaging data frame;
a display controlling step for controlling to display a reference image and a dynamic infrared thermal image acquired according to the acquired thermal imaging data frame;
a detecting step for detecting specified information related to a specified body thermal image based on the acquired thermal imaging data frame;
a comparing step for comparing the specified information acquired in the detecting step and/or an evaluating value acquired according to the specified information acquired by detection with a specified comparing value;
a selecting step for selecting special information related to the specified thermal imaging data frame based on a comparing result in the comparing step.

74. The infrared selecting method according to claim 73, further comprising:
an auxiliary information acquiring step for acquiring auxiliary information;
the comparing step for comparing the specified information acquired in the detecting step, the auxiliary information acquired in the auxiliary information acquiring step, the evaluating value acquired according to the specified information and the auxiliary information, the evaluating value acquired according to the specified information, the evaluating value acquired according to the auxiliary information, or a combination thereof, with the specified comparing value.

75. The infrared selecting method according to claim 74, wherein the specified information at least comprises a position, a dimension, an inclined angle, a correlation degree value of the specified body thermal image, or a combination thereof, and the auxiliary information at least comprises an analysis value, an environmental temperature, a wind speed, a background factor, humidity, a distance, or a combination thereof.

76. The infrared selecting method according to claim 74, wherein the special information is the thermal imaging data frame selected from the continuously acquired thermal imaging data frames, the thermal imaging data frame selected from the thermal imaging data frame after specified processing for the continuously acquired thermal imaging data frame, data acquired after specified processing for the thermal imaging data frame selected from the continuously acquired thermal imaging data frame, the specified information acquired by detection, the auxiliary information acquired by the auxiliary information acquiring part, the evaluating value acquired according to the specified information, the evaluating value acquired according to the auxiliary information, the evaluating value acquired according to the specified information and the auxiliary information, the indicating information generated according to the specified information, the indicating information generated according to the auxiliary information, the indicating information generated according to one or more of the above evaluating values, or a combination thereof.

77. The infrared selecting method according to claim 73, further comprising:
a comparing value updating step for updating the comparing value,
after the comparing value is updated, the comparing step being used for comparing the specified information acquired by the subsequent detection of the detecting step and/or the evaluating value acquired according to the specified information with the updated comparing value.

78. The infrared selecting method according to claim 73, further comprising an informing step for informing of the special information selected in the selecting step, updating information of the comparing value, an updating event of the comparing value, the latest special information selected by the selecting part, the special information related to the best thermal imaging data frame selected by the selecting part, the special information related to the thermal imaging data frame better than the specified comparing value selected by the selecting part, or a combination thereof.

79. The infrared selecting method according to claim 73, further comprising:
a body information selecting step for selecting the body information according to the body information stored in a storage medium, the storage medium being used for storing the body information and body identifying information related to the body information;
the detecting step for performing detection according to the body identifying information related to the detection, which is configured according to the body identifying information related to the selected body information.
